(19) United States
(12) Patent Application Publication
(10) Pub. No.: US 2025/0258887 A1
(43) Pub. Date: Aug. 14, 2025

(54) INFORMATION PROCESSING APPARATUS, VEHICLE CONTROL SYSTEM, MOVING BODY CONTROL SYSTEM, INFORMATION PROCESSING METHOD, AND COMPUTER PROGRAM PRODUCT

(71) Applicant: KABUSHIKI KAISHA TOSHIBA, Tokyo (JP)

(72) Inventors: Tomoya KASHIMATA, Sakado Saitama (JP); Yohei HAMAKAWA, Kawasaki Kanagawa (JP); Masaya YAMASAKI, Komae Tokyo (JP); Kosuke TATSUMURA, Yokohama Kanagawa (JP)

(73) Assignee: KABUSHIKI KAISHA TOSHIBA, Tokyo (JP)

(21) Appl. No.: 19/044,818

(22) Filed: Feb. 4, 2025

(30) Foreign Application Priority Data
Feb. 8, 2024 (JP) 2024-018133

(51) Int. Cl. G06F 17/11

(52) U.S. Cl. CPC G06F 17/11

(57) ABSTRACT

According to one embodiment, an information processing apparatus includes a hardware processor configured to repeatedly execute estimation processing, optimization processing, sampling processing, and addition processing. The hardware processor is configured to, in the estimation processing, estimate a surrogate model based on a history data set. The hardware processor is configured to, in the optimization processing, calculate, as N discrete parameters, a solution to an optimization problem of minimizing or maximizing the surrogate model. The hardware processor is configured to, in the sampling processing, sample an output value. The hardware processor is configured to, in the addition processing, add history data including the N discrete parameters and the output value to the history data set. The hardware processor is configured to further execute deletion processing of deleting at least a part of one or more pieces of history data from the history data set.

### CROSS-REFERENCE TO RELATED APPLICATIONS

This application is based upon and claims the benefit of priority from Japanese Patent Application No. 2024-018133, filed on Feb. 8, 2024; the entire contents of which are incorporated herein by reference.

### FIELD

Embodiments described herein relate generally to an information processing apparatus, a vehicle control system, a moving body control system, an information processing method, and a computer program product.

### BACKGROUND

An optimization method called black box optimization in which a black box function that is an unknown function is optimized by sampling the black box function from the outside is known. In the black box optimization, processing of finding an input value to the black box function is executed so as to optimize the black box function.

Among methods for the black box optimization, there is a method of repeating processing of estimating a surrogate model that approximates the black box function based on an output value sampled from the black box function, calculating a parameter for optimizing the surrogate model, and resampling the output value from the black box function by using the calculated parameter. In such a method, performance of optimization depends on accuracy of approximation of the surrogate model.

In recent years, a black box optimization method called factorization machine quantum annealing (FMQA) has attracted attention. This method is a method in which a factorization machine (FM) and optimization by a quantum annealing Ising machine (QA) are combined. This method optimizes a binary discrete parameter by using a surrogate model represented by a functional form including terms expressing interaction coefficients between variables by an inner product of vectors called factorization machines (FMs). In this method, coefficients of the surrogate model are learned by machine learning from output values obtained by sampling, and a solution that minimizes the trained surrogate model is calculated using the Ising machine. Then, in this method, processing of resampling a new output value from the black box function by using the solution that minimizes the surrogate model is repeated. Such a black box optimization method called FMQA can reduce the number of coefficients included in the surrogate model, so that optimization can be efficiently performed with a small arithmetic operation amount.

It can be said that such a black box optimization method is more effective when the number of times the sampling is performed is smaller and an evaluation result of the black box function for the found input value is more favorable. In particular, the black box optimization for optimizing a discrete parameter has just started to be studied, and there is room for performance improvement.

### BRIEF DESCRIPTION OF THE DRAWINGS

FIG. 1 is a configuration diagram of a control system according to a first embodiment;

FIG. 2 is a diagram illustrating a flow of processing in an information processing apparatus according to the first embodiment;

FIG. 3 is a configuration diagram of a control system according to a first modified example;

FIG. 4 is a configuration diagram of a control system according to a second modified example;

FIG. 5 is a configuration diagram of a control system according to a third modified example;

FIG. 6 is a diagram for describing mapping processing;

FIG. 7 is a configuration diagram of a control system according to a fourth modified example;

FIG. 8 is a diagram illustrating a flow of processing in an information processing apparatus according to a fifth modified example;

FIG. 9 is a configuration diagram of a control system according to a sixth modified example;

FIG. 10 is a configuration diagram of a control system according to a seventh modified example;

FIG. 11 is a configuration diagram of a control system according to an eighth modified example;

FIG. 12 is a configuration diagram of a vehicle control system according to a second embodiment;

FIG. 13 is a configuration diagram of a moving body control system according to a third embodiment;

FIG. 14 is a configuration diagram of a moving body control system according to a fourth embodiment;

FIG. 15 is a diagram illustrating an example of a time-series pattern of input and output of electric power;

FIG. 16 is a configuration diagram of a power system according to a fifth embodiment;

FIG. 17 is a configuration diagram of a suspension control system according to a sixth embodiment;

FIG. 18 is a diagram illustrating a first example of a configuration of a vehicle control system according to a seventh embodiment;

FIG. 19 is a diagram illustrating a second example of the configuration of the vehicle control system according to the seventh embodiment; and

FIG. 20 is a diagram illustrating an example of a hardware configuration of the information processing apparatus.

### DETAILED DESCRIPTION

According to an embodiment, an information processing apparatus includes a hardware processor. The hardware processor is configured to repeatedly execute estimation processing, optimization processing, sampling processing, and addition processing. The hardware processor is configured to, in the estimation processing, estimate a surrogate model that is obtained by modeling a black box function based on a history data set, and is a function including a plurality of discrete variables. The history data set includes history data including N discrete parameters input to the black box function and an output value output from the black box function in response to input of the N discrete parameters, N being an integer of 2 or more. The hardware processor is configured to, in the optimization processing, calculate, as the N discrete parameters, a solution to an optimization problem of minimizing or maximizing the surrogate model estimated in the estimation processing. The hardware processor is configured to, in the sampling processing, sample the output value output from the black box function based on sample values obtained corresponding to the N discrete parameters calculated in the optimization processing. The hardware processor is configured to, in the addition processing, add the history data including the N discrete parameters calculated in the optimization processing and the output value sampled in the sampling processing to the history data set. The hardware processor is configured to further execute deletion processing of deleting, from the history data set, at least a part of one or more pieces of the history data added in the addition processing before a predetermined number of times earlier or a predetermined time earlier.

Hereinafter, embodiments of the present invention will be described with reference to the accompanying drawings.

### Definitions

Sampling means processing of acquiring an output value of a function in a case where a certain input value is input to the function. The input value and the output value are arbitrary values. That is, the input value and the output value may be scalar values, or may be a plurality of scalar values or vectors. In addition, the input value and the output value may be values indicating a certain mode.

A black box function refers to a function that is a target of the sampling. The black box function may be an unknown function or a function having a known functional form.

N discrete parameters are input values input to the black box function. The N discrete parameters are a sequence of N discrete values. N is an integer of 2 or more. Each discrete parameter included in the N discrete parameters may represent a binary value of 0 or 1, may represent a binary value of +1 or −1, or may represent a ternary or higher discrete value. Furthermore, the N discrete parameters may be a sequence of N discrete values arranged in time series, or may be N discrete values arranged spatially.

A surrogate model is a function obtained by modeling the black box function. The surrogate model includes a plurality of discrete variables and outputs a scalar value. Each of the N discrete parameters input to the black box function corresponds to a value of any discrete variable among the plurality of discrete variables. The surrogate model outputs the scalar value when the N discrete parameters are input to the plurality of discrete variables. In the present embodiment, the surrogate model is represented by a quadratic function of the plurality of discrete variables. However, the surrogate model may be a quadratic or higher function of the plurality of discrete variables. Furthermore, a plurality of coefficients in the surrogate model may be discrete values or continuous values.

Estimation processing of estimating the surrogate model is processing of generating the surrogate model that approximates the black box function. In the present embodiment, the estimation processing of estimating the surrogate model is processing of generating the plurality of coefficients in the surrogate model of a predetermined functional form by machine learning, for example, such that a relationship between an input value and an output value approximates the black box function.

A combinatorial optimization solver is an apparatus that finds values of a plurality of discrete variables that optimize a function including the plurality of discrete variables. That is, the combinatorial optimization solver is an apparatus that finds a solution to a combination optimization problem for optimizing the function including the plurality of discrete variables. The combination optimization problem may be, for example, a problem of minimizing the function or a problem of maximizing the function. For example, the combinatorial optimization solver can solve the problem of minimizing the function and the problem of maximizing the function using the same algorithm by inverting a positive/negative sign of an output value of the function to be solved. Furthermore, the combination optimization problem may be the problem of minimizing the function under a predetermined constraint condition or the problem of maximizing the function under a predetermined constraint condition. The combinatorial optimization solver does not have to find an exact solution, and it is sufficient if the combinatorial optimization solver finds an approximate solution. That is, the combinatorial optimization solver may find a solution that is not an exact solution as long as the combinatorial optimization solver is an apparatus that finds a solution based on any algorithm. In addition, the combinatorial optimization solver may be able to calculate a solution to a problem of optimizing a function including continuous variables in addition to discrete variables.

Non-black box control processing refers to processing of controlling the apparatus by a method other than black box optimization. For example, the non-black box control processing may be processing of performing proportional integral derivative (PID) control or processing of performing control based on an optimal control theory.

A history data set is a set including history data. The history data set may be in a state of including only one piece of history data or in a state of an empty set including no history data. The history data includes the N discrete parameters input to the black box function and the output value sampled in response to the input of the N discrete parameters to the black box function. In the present embodiment, the surrogate model inductively estimates the plurality of coefficients included in the predetermined functional form by machine learning, a statistical method, or the like using the history data set.

The history data may include, as the N discrete parameters, one or more values obtained by converting the N discrete parameters according to a predetermined rule. In addition, in a case where the history data is data in which the output value includes a plurality of elements, the history data may include, as the output value, a scalar value obtained by converting the plurality of elements according to a predetermined rule. The history data is represented with a small data size by including the N discrete parameters or the output value obtained by such conversion.

### First Embodiment

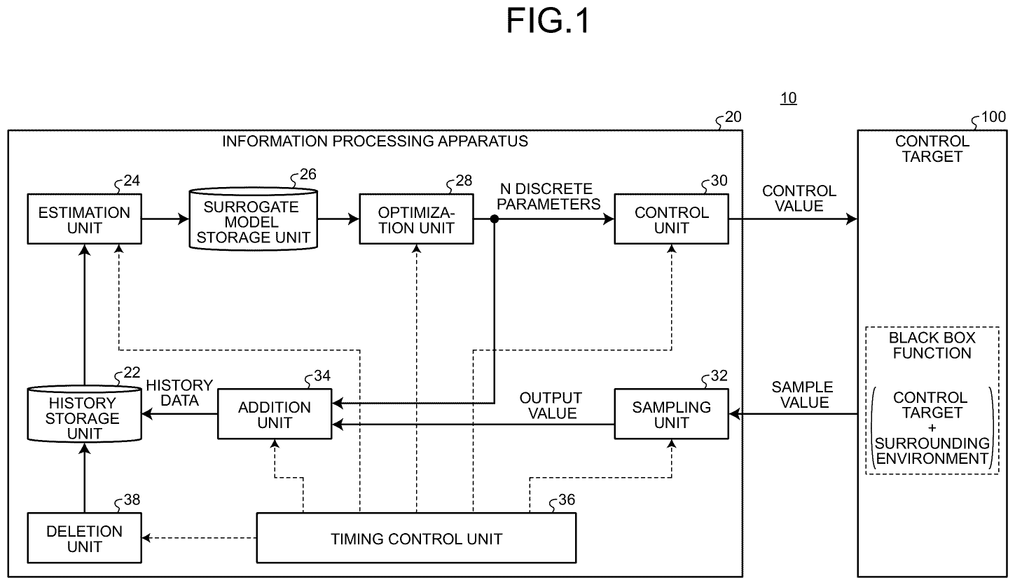

FIG. 1 is a diagram illustrating a configuration of a control system 10 according to a first embodiment together with a control target 100.

The control system 10 according to the first embodiment includes the control target 100 and an information processing apparatus 20.

The control target 100 receives a control value from the information processing apparatus 20 and operates according to the received control value. In the present embodiment, the control target 100 receives the control value that changes in time series from the information processing apparatus 20 and performs an operation that changes with time according to the received control value. The control target 100 may receive one type of control value, or may receive two or more types of control values in parallel. The control value may be digital data, a value representing a mode of an operation of the control target 100, or an analog quantity such as a current or a voltage.

In addition, the control target 100 outputs a sensor value output from a sensor that observes the control target 100. The control target 100 may output one type of sensor value or may output two or more types of sensor values.

The information processing apparatus 20 controls the control target 100 based on a black box optimization method. More specifically, the information processing apparatus 20 estimates the surrogate model obtained by modeling the black box function based on the history data set. Subsequently, the information processing apparatus 20 calculates, as the N discrete parameters, a solution to an optimization problem of minimizing or maximizing the estimated surrogate model. Subsequently, the information processing apparatus 20 provides the control value based on the calculated N discrete parameters to the control target 100 to control the operation of the control target 100. At the same time, the information processing apparatus 20 samples an output value based on a sample value output from the control target 100 by providing the control value. Then, the information processing apparatus 20 adds the history data including the N discrete parameters and the output value to the history data set, and repeats the processing from the processing of estimating the surrogate model again.

In the present example, the information processing apparatus 20 acquires the sensor value output from the sensor that observes the control target 100 as the sample value output from the control target 100 by providing the control value. However, the information processing apparatus 20 may simulate the operation of the control target 100 according to the provision of the control value and acquire a simulation result obtained by the simulation as the sample value output from the control target 100 by providing the control value.

In the present embodiment, the black box function is a function to which the N discrete parameters are input as input values and from which the output value is output in response to the input of the N discrete parameters. In the present embodiment, the black box function is a function representing the control target 100 and a surrounding environment of the control target 100, and the functional form of the black box function may be unknown.

The information processing apparatus 20 includes a history storage unit 22, an estimation unit 24, a surrogate model storage unit 26, an optimization unit 28, a control unit 30, a sampling unit 32, an addition unit 34, a timing control unit 36, and a deletion unit 38.

The history storage unit 22 stores the history data set. New history data including the N discrete parameters based on which the output value is output and the sampled output value is added to the history data set each time the output value is sampled by the sampling unit 32.

The history data set can be regarded as a set of records in which the history data is registered. The history data set includes the history data in such a way that an order can be identified. The order of the history data is, for example, an order in which the sample value corresponding to the output value included in the history data is output, an order in which the output value included in the history data is sampled, or an order in which the history data is added to the history data set. The order of the history data may be an order according to another criterion for sorting the history data.

In addition, the order of the history data may be identified by a data structure of the history data set, may be identified by an address on a memory in which the history data is recorded, may be identified by adding a numerical value indicating the order to the history data, or may be identified by adding a time to the history data. For example, in a case where the history storage unit 22 is a memory having a cyclic First In First Out (FIFO) structure, the order of the history data is identified by the address on the memory and a head address and an end address of a cyclic First In First Out (FIFO).

In addition, the history data set may include the history data such that the time can be identified instead of or in addition to the order. The time of the history data is, for example, a time when the sample value corresponding to the output value included in the history data is output, a time when the output value included in the history data is sampled, or a time when the history data is added to the history data set. The time of the history data may be a time according to another criterion.

The estimation unit 24 executes estimation processing of estimating the surrogate model. That is, the estimation unit 24 estimates, based on the history data set stored in the history storage unit 22, the surrogate model that is a function obtained by modeling the black box function and including the plurality of discrete variables. For example, the estimation unit 24 performs machine learning on the plurality of coefficients in the surrogate model based on one or more pieces of history data included in the history data set such that a relationship between the input value and the output value approximates the black box function. As a result, in a case where the N discrete parameters included in each piece of history data included in the history data set are substituted into the plurality of discrete variables, the estimation unit 24 can generate the surrogate model approximating a function that outputs the output value included in the corresponding history data.

In the present embodiment, the surrogate model has a preset functional form. That is, in the present embodiment, the surrogate model is a function in which a coefficient is unknown and one or more discrete variables included in each term are known. In the present embodiment, the surrogate model has a term obtained by multiplying at least two or more discrete variables and the coefficient. As a result, the surrogate model can have a term representing a correlation between different discrete variables.

For example, the surrogate model may be represented by a quadratic function including the N discrete variables as in Formula (1).

$$y = {\sum }_{i = 1}^{N} {\sum }_{j = 1}^{N} {W}_{ij} {x}_{i} {x}_{j} + {\sum }_{i = 1}^{N} {w}_{i} {x}_{i} + {w}_{0} \qquad ( 1 )$$

y is a real number representing an evaluation value of the surrogate model.
i and j represent integers of 1 or more and N or less.
xᵢ represents the i-th discrete variable among the N discrete variables.
xⱼ represents the j-th discrete variable among the N discrete variables.
wᵢⱼ represents a coefficient multiplied by a quadratic term including xᵢ and xⱼ, and is a real number.
wᵢ represents a coefficient multiplied by a linear term including xᵢ, and is a real number.
w₀ represents a coefficient multiplied by a zero-order term, that is, a constant term, and is a real number.
wᵢⱼ, wᵢ, and w₀ may be binary values of 0 or 1, binary values of −1 or 1, or the like.

As described above, the surrogate model of Formula (1) is a function represented by a quadratic polynomial in which the evaluation value includes the N discrete variables.

In the present embodiment, the surrogate model is represented by a quadratic function including the N discrete variables used for a factorization machine as in Formula (2). The quadratic function of Formula (2) is a function having K quadratic terms including xᵢ and xⱼ. In the factorization machine, the coefficient wᵢⱼ in Formula (1) is expressed by an inner product of a vector vᵢ associated with xᵢ and a vector vⱼ associated with xⱼ.

$$y = {\sum }_{i = 1}^{N} {\sum }_{j = 1}^{N} {\sum }_{k = 1}^{N} {v}_{ik} {v}_{jk} {x}_{i} {x}_{j} + {\sum }_{i = 1}^{N} {w}_{i} {x}_{i} + {w}_{0} \qquad ( 2 )$$

K is an integer of 2 or more and less than N.
k is an integer of 1 or more and K or less.
vᵢₖ represents a coefficient multiplied by the k-th quadratic term among the K quadratic terms including xᵢ and x_{z}. z is an arbitrary integer of 1 or more and N or less.
vⱼₖ represents a coefficient multiplied by the k-th quadratic term among the K quadratic terms including x_{z} and xⱼ.

The surrogate model of Formula (2) represents wᵢⱼ, which is a coefficient of the quadratic term in the surrogate model of Formula (1), by an inner product of a vector (vᵢ₁, vᵢ₂, . . . , or vᵢₖ) and a vector (vⱼ₁, vⱼ₂, . . . , or vᵢₖ). When K is smaller than N, the number of coefficients of such a surrogate model of Formula (2) is smaller than that of the surrogate model of Formula (1). Therefore, the estimation unit 24 can accurately estimate the surrogate model of Formula (2) based on a small number of pieces of history data by setting K to be small.

In a case of such a surrogate model, in a case where the same N discrete parameters are input, the closer the evaluation value y is to the output value output from the black box function, the more accurately the surrogate model approximates the black box function. However, in some cases, the surrogate model is not able to achieve approximation with high accuracy over the entire domain of the black box function. For example, there is a possibility that the original functional form of the surrogate model cannot achieve approximation over the entire domain of the black box function. However, there is a high possibility that local approximation can be achieved with a function system of the surrogate model, and in this case, the local approximation can be achieved by intentionally limiting the history data used for inducement. In addition, in a case of controlling the control target 100 in real time, it is assumed that the number of samples required to approximate the entire domain cannot be secured. Even in such a case, if the surrogate model locally approximates a range of the latest output value, the control target 100 can be appropriately controlled.

The surrogate model storage unit 26 stores the surrogate model estimated by the estimation unit 24. Information regarding the surrogate model to be stored may be only the coefficient. Since the functional form of the surrogate model is limited, the information regarding the surrogate model to be exchanged may be only the coefficient of the surrogate model.

The optimization unit 28 executes optimization processing of optimizing the surrogate model stored in the surrogate model storage unit 26. That is, the optimization unit 28 calculates the solution to the optimization problem of minimizing or maximizing the surrogate model stored in the surrogate model storage unit 26 as the N discrete parameters.

The optimization unit 28 executes the optimization processing by using the combinatorial optimization solver. The optimization unit 28 may have a function of executing the combinatorial optimization solver. Furthermore, the optimization unit 28 may provide the optimization problem to the combinatorial optimization solver executed by an accelerator or an off-loader, for example, to acquire the solution. Furthermore, the optimization unit 28 may provide the optimization problem to, for example, a server apparatus or the like that executes the combinatorial optimization solver via a network to acquire the solution.

The optimization unit 28 may execute the optimization processing by using an Ising machine as the combinatorial optimization solver. In a case of using the Ising machine, the optimization unit 28 converts the surrogate model into a formula representing Ising energy including N Ising spins as in Formula (3), and calculates values of the N Ising spins that minimize Formula (3).

$$E = - {\sum }_{i < j}^{N} {J}_{ij} {s}_{i} {s}_{j} + {\sum }_{i = 1}^{N} {h}_{i} {s}_{i} \qquad ( 3 )$$

E represents the Ising energy.
sᵢ represents the i-th Ising spin among the N Ising spins.
sⱼ represents the j-th Ising spin among the N Ising spins.
Jᵢⱼ represents an interaction coefficient multiplied by a quadratic term including sᵢ and sⱼ.
hᵢ represents an external magnetic field multiplied by a linear term including Si.

Furthermore, the optimization unit 28 may be a simulated branch machine. The simulated branch machine is disclosed, for example, in JP 2021-060864 A, JP 2019-145010 A, JP 2019-159566 A, JP 2021-043667 A, and JP 2021-043589 A and Hayato Goto, Kosuke Tatsumura and Alexander R. Dixon, “Combinatorial optimization by simulating adiabatic bifurcations in nonlinear Hamiltonian systems,” Science Advances 5, eaav2372, 2019, and Hayato Goto, Kotaro Endo, Masaru Suzuki, Yoshisato Sakai, Taro Kanao, Yohei Hamakawa, Ryo Hidaka, Masaya Yamasaki and Kosuke Tatsumura, “High-performance combinatorial optimization based on classical mechanics”, Science Advances 7, eabe7953, 2021. The simulated branch machine is also referred to as a quantum-inspired algorithm because the simulated branch machine was discovered by being inspired by a quantum mechanical optimization method based on a quantum adiabatic theorem. The simulated branch machine can solve a combinatorial optimization problem in which a cost function is a quadratic function of a plurality of decision variables. The simulated branch machine can also solve a combinatorial optimization problem in which a cost function is a cubic or higher function of a plurality of decision variables, that is, a higher order binary optimization (HUBO) problem. For example, the simulated branch machine that solves the HUBO problem is disclosed in JP 2021-043667 A. Furthermore, the simulated branch machine can also solve a combination optimization problem including a variable of a continuous value in some or all of a plurality of decision variables. The simulated branch machine that solves a combination optimization problem including a variable of a continuous value in some or all of a plurality of decision variables is disclosed in JP 2021-043589 A. Such a simulated branch machine can calculate an approximate solution in a short time by using a computer with a high degree of parallelism.

The optimization unit 28 may execute the optimization processing by using the Ising machine using simulated annealing or digital annealing instead of the simulated branch machine.

The optimization unit 28 provides the calculated N discrete parameters to the control unit 30. Furthermore, the optimization unit 28 provides the calculated N discrete parameters to the addition unit 34.

The control unit 30 executes control processing of controlling the control target 100 based on the N discrete parameters calculated by the optimization unit 28. Specifically, the control unit 30 generates the control value based on the N discrete parameters calculated by the optimization unit 28. Then, the control unit 30 provides the generated control value to the control target 100. As a result, the control target 100 can operate according to the provided control value.

The control unit 30 may directly provide the N discrete parameters as the control values to the control target 100. Alternatively, the control unit 30 may perform format conversion on the N discrete parameters, and provide the control value represented by digital data in a predetermined format or a numerical value to the control target 100.

Each of the N discrete parameters may represent a mode of any operation of the control target 100. Such N discrete parameters may be optimized under the condition of a one-hot constraint such that two or more discrete parameters do not become 1 at the same time. In a case where such N discrete parameters are acquired, the control unit 30 determines a mode of the control target 100 based on the acquired N discrete parameters, and provides a value representing the determined mode to the control target 100 as the control value. Alternatively, the control unit 30 may provide the N discrete parameters to an analog circuit including a transistor, a relay, a photocoupler, and the like, generate a current, a voltage, or the like for driving or controlling the control target 100, and provide the generated current, voltage, or the like to the control target 100 as the control value.

The sampling unit 32 executes sampling processing. More specifically, the sampling unit 32 samples the output value output from the black box function based on the sample value obtained by providing, to the control target 100, the control value corresponding to the N discrete parameters calculated by the control unit 30 in the optimization processing.

The output value is, for example, a value obtained by evaluating the N discrete parameters input to the black box function based on an evaluation index such as a fuel consumption, an electric power consumption, or a battery charge/discharge electric power amount. The sampling unit 32 may sample the acquired sample value as it is as the output value. Furthermore, the sampling unit 32 may sample the output value by converting the sample value according to a predetermined rule. Alternatively, in a case where the sample value includes a plurality of element values, the sampling unit 32 may sample, as the output value, a scalar value obtained by converting the plurality of element values according to a predetermined rule.

In the present example, the sampling unit 32 acquires, as the sample value, the sensor value output from a sensor that observes the operation of the control target 100. For example, the sensor may be an apparatus that acquires a control result for the control target 100 that is a machine or a device. The sensor may be an apparatus that acquires information regarding a status of the control target 100 or the surrounding environment of the control target 100. The sensor may be an apparatus that acquires a global positioning system (GPS) signal and detects a position or speed of the control target 100 or a peripheral device. The sampling unit 32 may acquire, as the sample value, the simulation result obtained by simulating the operation of the control target 100.

The sampling unit 32 may or may not actively determine a timing to acquire the sample value. For example, in a case of acquiring a speed of a vehicle, the sampling unit 32 acquires the speed at each predetermined sampling timing. Furthermore, for example, in a case of acquiring a distance detected by a distance measurement apparatus such as a light detection and ranging (Lider), the sampling unit 32 acquires the distance based on a timing at which the distance measurement apparatus receives light reflected from an object.

The sampling unit 32 may acquire a plurality of sample values each time the control unit 30 provides the control value based on the N discrete parameters calculated by the optimization processing to the control target 100 once. Then, the sampling unit 32 may generate one output value based on the plurality of acquired sample values, or may generate the output value based on a corresponding sample value for each of the plurality of acquired sample values.

The addition unit 34 executes addition processing of adding the history data to the history data set stored in the history storage unit 22. More specifically, the addition unit 34 acquires the N discrete parameters calculated by the optimization unit 28 in the optimization processing and the output value output by the sampling unit 32. Then, the addition unit 34 generates the history data including the N discrete parameters calculated by the optimization processing and the output value, and adds the generated history data to the history data set.

In a case where the sampling unit 32 outputs a plurality of output values each time the control value is provided to the control target 100 once, the addition unit 34 generates the history data for each of the plurality of output values and adds the history data to the history data set. In this case, the addition unit 34 sets different ranks for the plurality of pieces of history data generated in response to providing the control value to the control target 100 once.

The timing control unit 36 issues an instruction to repeatedly execute the estimation processing by the estimation unit 24, the optimization processing by the optimization unit 28, the control processing by the control unit 30, the sampling processing by the sampling unit 32, and the addition processing by the addition unit 34. As a result, the timing control unit 36 can control the control target 100 based on the black box optimization method for generating the N discrete parameters for optimizing the black box function.

The combinatorial optimization solver used by the optimization unit 28 has a trade-off relationship between a solution quality and a calculation speed in a case of calculating the approximate solution. Such a combinatorial optimization solver may have a parameter for setting the solution quality, that is, a parameter for setting the calculation speed. In the present embodiment, a parameter for setting the solution quality is referred to as a solution control parameter. For example, in the simulated branch machine and the simulated annealing, the number of steps, which is the number of times iterative operation is performed, is set in order to execute the iterative operation. The simulated branch machine and the simulated annealing tend to provide a higher solution quality as the number of steps increases. Improvement in the solution quality means that, for example, a solution close to the exact solution is obtained or a probability of satisfying the constraint condition increases. On the other hand, in the simulated branch machine and the simulated annealing, a time taken to obtain the solution increases as the number of steps increases. The solution control parameter does not have to have a trade-off relationship with an execution time as long as the solution control parameter affects randomness of the solution. Here, a low solution quality means that the randomness of the solution is high. As the randomness of the solution increases, the combinatorial optimization solver actively searches for a region that is not currently searched, and it is possible to prevent the search from being performed only locally.

The timing control unit 36 may change the solution control parameter in the optimization unit 28 in the middle of processing of repeating the black box optimization processing. For example, the timing control unit 36 may set the solution control parameter so as to increase the randomness at an initial stage of the repetition, and change the solution control parameter so as to improve the solution quality after the initial stage of the repetition. For example, the timing control unit 36 may reduce the number of steps in the initial stage of the repetitive control, and may increase the number of steps after the initial stage of the repetitive control. As a result, the timing control unit 36 can execute the optimization processing at a high calculation speed in a period from the start of control until the N discrete parameters of a certain quality are generated, and can execute the optimization processing with a high quality after the N discrete parameters of the certain quality are generated. The timing control unit 36 may change the solution control parameter stepwise so as to improve the solution quality as the number of repetitions of the black box optimization processing increases. For example, the timing control unit 36 may change the number of steps stepwise, for example, as the number of repetitions of the black box optimization processing increases.

The deletion unit 38 executes deletion processing of deleting, from the history data set stored in the history storage unit 22, at least a part of one or more pieces of history data added in the addition processing before a predetermined number of times earlier or a predetermined time earlier.

For example, in a case where the history data set includes more history data than a predetermined number, the deletion unit 38 deletes some pieces of history data included in the history data set such that at least the predetermined number of pieces of history data remain in the history data set. In this case, the deletion unit 38 preferentially deletes the earlier history data in the history data set. That is, the deletion unit 38 preferentially deletes the history data added earlier than the history data added later. That is, the deletion unit 38 preferentially deletes old history data over new history data.

For example, after executing the addition processing, the deletion unit 38 determines whether or not the history data set includes more history data than the predetermined number, and deletes, in a case where the history data set includes more history data than the predetermined number, a predetermined number of pieces of history data in order, starting from the history data added earlier. Furthermore, in a case where the history data set includes more history data than the predetermined number after executing the addition processing, the deletion unit 38 may select a predetermined number of history data in order, starting from the history added later, and delete all the pieces of history data that have not been selected.

By executing such processing, the deletion unit 38 can cause the predetermined number of pieces of history data added later to remain in the history data set. That is, the deletion unit 38 can cause the predetermined number of pieces of history data most recently added to remain in the history data set.

In a case where the time is added to the history data, for example, the deletion unit 38 may delete some of the pieces of history data included in the history data set such that at least the history data of a time later than a predetermined time remains in the history data set. In this case, the deletion unit 38 preferentially deletes the history data of an earlier time in the history data set. The predetermined time is, for example, a predetermined time before a time of the latest history data, a predetermined time before a current reference processing time, or the like.

After executing the addition processing, the deletion unit 38 determines whether or not the history data set includes the history data before the predetermined time, and in a case where the history data set includes the history data before the predetermined time, the deletion unit 38 deletes a predetermined number of pieces of history data in order, starting from the oldest history data before the predetermined time. Alternatively, in a case where the history data set includes the history data before the predetermined time, the deletion unit 38 may delete all the pieces of history data before the predetermined time.

By executing such processing, the deletion unit 38 can remain the history data added to the history data set after the predetermined time in the history data set.

Such a deletion unit 38 can cause the estimation unit 24 to estimate the surrogate model by using the most recently added history data. That is, the deletion unit 38 can cause the estimation unit 24 to estimate the surrogate model without using relatively old history data. Therefore, in a case where the control target 100 is controlled in real time by, for example, the black box optimization, the deletion unit 38 can cause the estimation unit 24 to estimate the surrogate model without using relatively old history data that deteriorates approximation performance. As a result, the deletion unit 38 can cause the black box function that changes with time to estimate the surrogate model that achieves the approximation with high accuracy.

The deletion unit 38 may set specific history data included in the history data set as fixed history data and does not have to delete the fixed history data even if the fixed history data is history data preceding a predetermined order or history data before a predetermined time. As a result, the deletion unit 38 can remain the specific history data that does not change with time, for example, in the history data set.

Further, in a case where a delete flag for identifying whether or not the history data included in the history data set has been logically deleted is included, the deletion unit 38 may logically delete the history data by rewriting the delete flag. In this case, the deletion unit 38 can include the deleted history data again in the history data set by rewriting the delete flag of the deleted history data again.

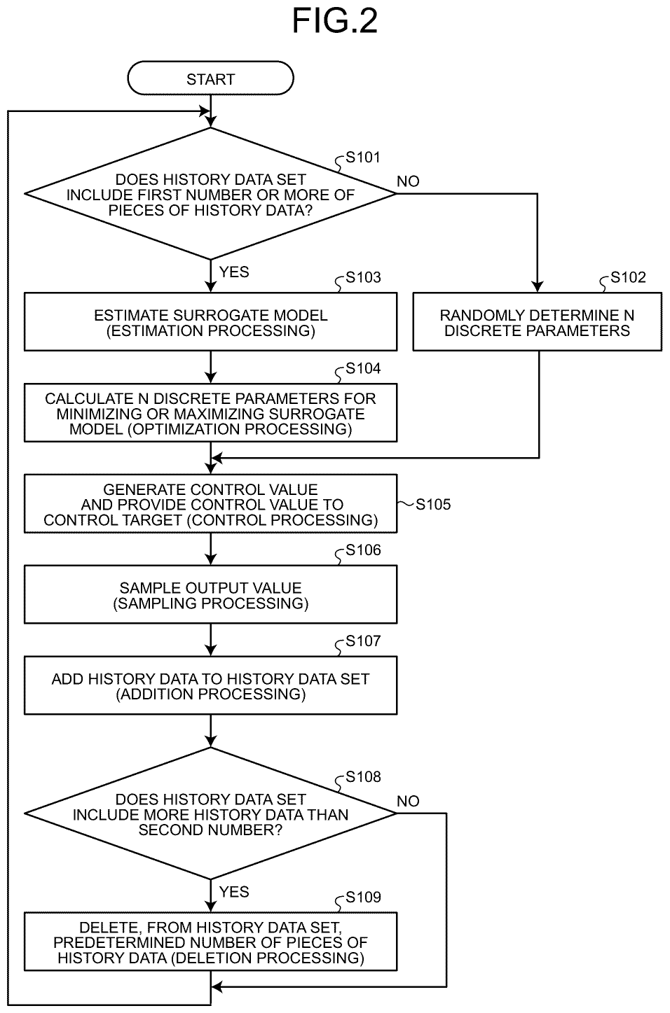

FIG. 2 is a flowchart illustrating a flow of processing in the information processing apparatus 20. The information processing apparatus 20 executes the processing on the control target 100 in the flow illustrated in FIG. 2.

First, in S101, the information processing apparatus 20 determines whether or not the history data set includes a first number or more of pieces of history data. The first number is a predetermined number of two or more.

In a case where the history data set does not include the first number or more of pieces of history data (No in S101), the information processing apparatus 20 advances the processing to S102. In a case where the history data set includes at least the first number of pieces of history data (Yes in S101), the information processing apparatus 20 advances the processing to S103. In the present example, the history data set is an empty set that does not include the history data at a stage when the processing of FIG. 2 is started.

In S102, the information processing apparatus 20 randomly determines the N discrete parameters based on, for example, a random number or the like. The information processing apparatus 20 may select N discrete values set in advance as the N discrete parameters. The preset N discrete values may be different for each repetition of the flow. For example, the preset N discrete values may be set at the time of factory shipment or the like, or may be a result of immediately preceding control processing on the control target 100. After completing S102, the information processing apparatus 20 advances the processing to S105.

In S103, the information processing apparatus 20 executes the estimation processing of estimating the surrogate model based on the history data set. That is, the estimation unit 24 estimates the surrogate model by performing machine learning based on the history data set in the information processing apparatus 20. As a result, in a case where the N discrete parameters included in the history data included in the history data set are substituted into the plurality of discrete variables, the information processing apparatus 20 can generate the surrogate model approximating the function that outputs the output value included in the corresponding history data.

Subsequently, in S104, the information processing apparatus 20 executes the optimization processing of optimizing the surrogate model. More specifically, the information processing apparatus 20 calculates, as the N discrete parameters, the solution to the optimization problem of minimizing or maximizing the surrogate model by using the combinatorial optimization solver. After completing S104, the information processing apparatus 20 advances the processing to S105.

In S105, the information processing apparatus 20 executes the control processing of controlling the control target 100 based on the N discrete parameters. More specifically, the information processing apparatus 20 generates the control value based on the N discrete parameters. Then, the information processing apparatus 20 provides the generated control value to the control target 100 and controls the control target 100.

Subsequently, in S106, the information processing apparatus 20 executes the sampling processing of sampling the sample value obtained by providing the control value corresponding to the N discrete parameters to the control target 100 as the output value output from the black box function.

Subsequently, in S107, the information processing apparatus 20 executes the addition processing of adding the history data to the history data set. More specifically, the information processing apparatus 20 generates the history data including the N discrete parameters calculated or determined in S102 or S104 and the output value sampled in S106, and adds the generated history data to the history data set.

Subsequently, in S108, the information processing apparatus 20 determines whether or not the history data set includes more history data than a second number. The second number is a predetermined number of two or more. The second number may be the same as or different from the first number.

In a case where the history data set does not include the history data more than the second number (No in S108), the information processing apparatus 20 skips S109 and returns the processing to S101. In a case where the history data set includes the history data more than the second number (Yes in S108), the information processing apparatus 20 advances the processing to S109.

In S109, the information processing apparatus 20 executes the deletion processing of deleting, from the history data set, at least some of one or more pieces of history data added in the addition processing executed a predetermined number of times earlier or executed a predetermined time earlier. In the present example, the information processing apparatus 20 deletes a predetermined number of pieces of history data, for example, one piece of history data. In this case, the information processing apparatus 20 preferentially deletes the history data that is earlier in order in the history data set, that is, the history data added earlier. That is, the information processing apparatus 20 preferentially deletes old history data over new history data.

The information processing apparatus 20 may select the second number of pieces of history data starting from the history data added later and delete all the pieces of history data that have not been selected, instead of deleting the predetermined number of pieces of history data.

After completing the processing of S109, the information processing apparatus 20 returns the processing to S101. Then, the information processing apparatus 20 repeatedly executes the processing from S101 to S109. For example, the information processing apparatus 20 may execute the processing from S101 to S109 every predetermined time. Furthermore, the information processing apparatus 20 may execute the processing from S101 to S109 every time a repeatedly occurring predetermined event is detected.

The information processing apparatus 20 according to the first embodiment as described above can estimate the surrogate model by using the most recently added history data without using relatively old history data. The relatively old history data may include the output value that is greatly different from the output value of the black box function at the present time. Therefore, in a case where the surrogate model is estimated using relatively old history data, accuracy in the approximation for the black box function at the present time may decrease. On the other hand, since the information processing apparatus 20 according to the first embodiment does not use the relatively old history data but uses the history data added most recently, it is possible to estimate the surrogate model approximating the black box function with high accuracy at the present time.

As a result, with the information processing apparatus 20 according to the first embodiment, it is possible to accurately optimize the black box function around the currently sampled control value (a region where control inputs are similar) even with a small number of samplings. Therefore, with the information processing apparatus 20 according to the first embodiment, for example, the control by the black box optimization can be performed with high responsiveness and accuracy for the dynamically changing control target 100.

### First Modified Example

Next, a first modified example of the control system 10 according to the first embodiment will be described.

Since each of modified examples of the control system 10 described below has substantially the same function and configuration as those of the control system 10 according to the first embodiment described with reference to FIGS. 1 and 2, components having substantially the same function and configuration are denoted by the same reference numerals, and a detailed description thereof is omitted except for differences. Further, any two or more of the plurality of modified examples described below may be simultaneously applied to the control system 10 according to the first embodiment.

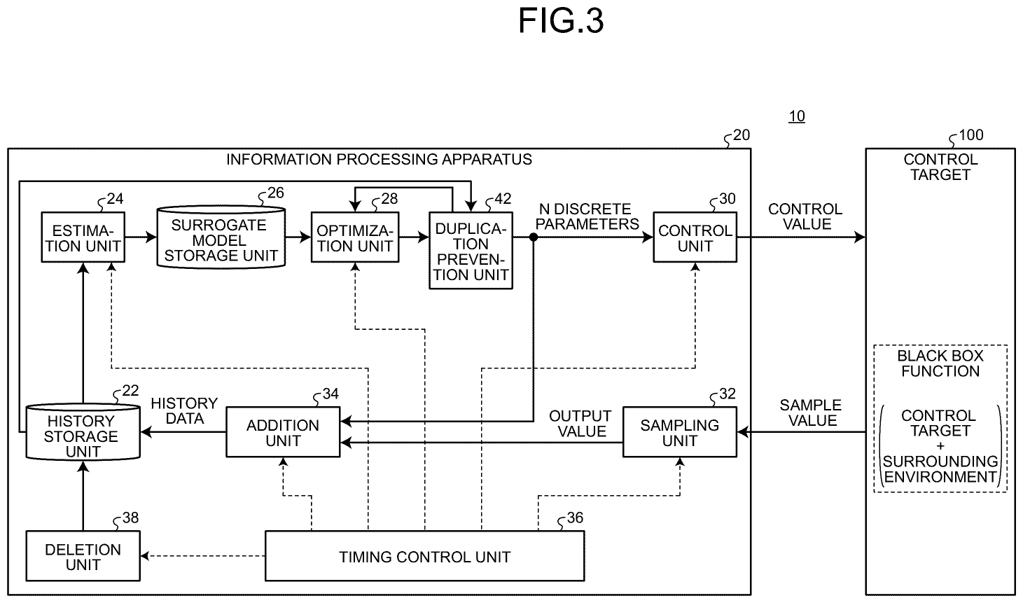

FIG. 3 is a diagram illustrating a configuration of a control system 10 according to the first modified example together with a control target 100.

An information processing apparatus 20 according to the first modified example further includes a duplication prevention unit 42 that executes duplication prevention processing.

The duplication prevention unit 42 acquires the N discrete parameters calculated by an optimization unit 28 executing optimization processing, on behalf of a control unit 30. In a case where the N discrete parameters calculated by the optimization unit 28 are acquired, the duplication prevention unit 42 determines whether or not the N discrete parameters coincide with the N discrete parameters that are the basis of a control value provided to the control target 100 a predetermined number of times earlier or a predetermined time earlier.

For example, the duplication prevention unit 42 determines whether or not the N discrete parameters calculated by the optimization unit 28 coincide with the N discrete parameters included in any of one or more pieces of history data from the latest history data stored in a history storage unit 22 to the history data that is a predetermined number of times earlier in order.

Alternatively, the duplication prevention unit 42 determines whether or not the N discrete parameters calculated by the optimization unit 28 coincide with the N discrete parameters included in any of one or more pieces of history data from the history data of the latest time stored in the history storage unit 22 to the history data of a time a predetermined time earlier.

When they do not coincide with each other, the duplication prevention unit 42 provides the acquired N discrete parameters as they are to the control unit 30.

In a case where they coincide with each other, the duplication prevention unit 42 causes the optimization unit 28 to re-execute the optimization processing without providing the acquired N discrete parameters to the control unit 30. Then, the duplication prevention unit 42 acquires new N discrete parameters calculated by the re-executed optimization processing again.

The optimization unit 28 may repeatedly calculate the same N discrete parameters in a relatively short period. In a case where the same N discrete parameters are repeatedly calculated in a relatively short period, a difference between a plurality of pieces of history data included in the history data set is reduced. In a case where the difference between the plurality of pieces of history data included in the history data set is reduced, a probability that the same N discrete parameters are calculated in the surrogate model is also increased. As a result, even if the information processing apparatus 20 repeats estimation processing, the optimization processing, sampling processing, and addition processing, a loop in which the same N discrete parameters are continuously calculated occurs. In a case where such a loop occurs, it is difficult for the information processing apparatus 20 to estimate the surrogate model approximating the black box function, and control by the black box optimization may be difficult.

In a case where the same N discrete parameters are acquired a predetermined number of times earlier or a predetermined time earlier, the duplication prevention unit 42 re-executes the optimization processing to acquire the N discrete parameters again. As a result, the duplication prevention unit 42 can reduce a probability of repeatedly acquiring the same N discrete parameters in a relatively short period, and can include a wide variety of different pieces of history data in the history data set. As a result, the information processing apparatus 20 can estimate the surrogate model that accurately approximates the black box function and perform appropriate black box optimization control.

The duplication prevention unit 42 may store the N discrete parameters provided to the control unit 30 separately from the history data set instead of comparing the N discrete parameters calculated by the optimization unit 28 with the N discrete parameters included in the history data set. In this case, the duplication prevention unit 42 compares the N discrete parameters calculated by the optimization unit 28 with the N discrete parameters stored separately.

In addition, the duplication prevention unit 42 may cause the optimization unit 28 to re-execute the optimization processing until the N discrete parameters calculated by the optimization processing do not coincide with the N discrete parameters included in any of one or more pieces of history data from the latest history data stored in the history storage unit 22 to the history data that is a predetermined times earlier in order. In addition, the duplication prevention unit 42 may set an upper limit value of the number of times of re-execution in advance, and when re-execution is performed for the number of times corresponding to the upper limit value, the re-execution may be stopped and the calculated N discrete parameters may be provided to the control unit 30.

Furthermore, in a case of causing the optimization unit 28 to re-execute the optimization processing, the duplication prevention unit 42 may change a setting value of the optimization unit 28 so as to increase a probability that N different discrete parameters are calculated. For example, the duplication prevention unit 42 may change a solution control parameter such as the number of steps so as to increase randomness of the solution control parameter every time the optimization unit 28 is caused to re-execute the optimization processing. That is, the duplication prevention unit 42 may change the setting value so as to increase the randomness of the solution every time the optimization processing is re-executed.

Furthermore, the optimization unit 28 may execute the optimization processing with an algorithm that increases the probability that N different discrete parameters are calculated. For example, the optimization unit 28 may execute the optimization processing by using an algorithm called tab search. In a case of using the algorithm called tab search, the optimization unit 28 minimizes an objective function including a term that increases Ising energy as the solution is closer to a pre-registered solution. In this case, the optimization unit 28 registers a predetermined number of solutions from the most recently calculated solution to a solution calculated a predetermined number of times earlier, and executes the optimization processing of calculating a solution different from the predetermined number of solutions.

### Second Modified Example

Next, a second modified example of the control system 10 according to the first embodiment will be described.

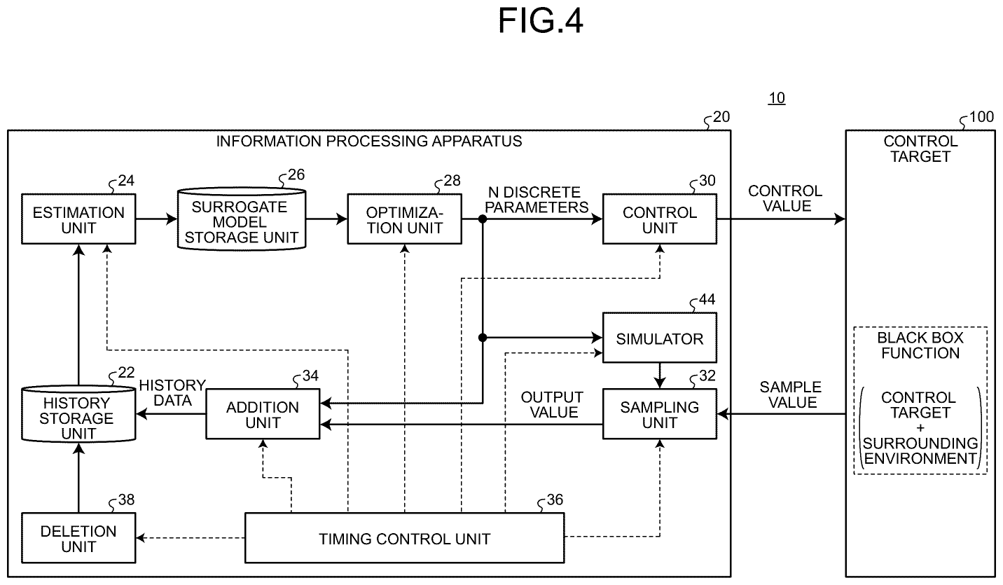

FIG. 4 is a diagram illustrating a configuration of a control system 10 according to the second modified example together with a control target 100.

An information processing apparatus 20 according to the second modified example further includes a simulator 44. The simulator 44 acquires the N discrete parameters from an optimization unit 28, and simulates an operation in a case where the control value based on the acquired N discrete parameters is provided to the control target 100 by information processing. For example, the simulator 44 outputs, as a simulation result, an evaluation index such as a fuel consumption, an electric power consumption, or a battery charge/discharge electric power amount in a case where the control value based on the N discrete parameters is provided to the control target 100.

Furthermore, the simulator 44 simulates the operation in a case where the control value based on the N discrete parameters is provided to the control target 100 by using a sensor value output from a sensor that observes the control target 100. As a result, the simulator 44 can accurately simulate the operation in a case where the control value based on the N discrete parameters is provided to the control target 100. The sensor value may be obtained by acquiring information regarding a surrounding environment or may be obtained by acquiring a value of the black box function.

In the second modified example, a sampling unit 32 acquires, as a sample value, the simulation result obtained by providing the N discrete parameters to the simulator 44 in the sampling processing. Then, the sampling unit 32 samples the output value predicted to be output from the black box function in response to the input of the N discrete parameters based on the sample value output from the simulator 44. Furthermore, for example, a control unit 30 outputs the control value to the control target 100 only when the sample value output by the simulator 44 exceeds a certain reference value.

For example, in a case where the control target 100 is a drive motor of an automobile, there is a possibility that the information processing apparatus 20 provides some sort of limitation to the control value based on the N discrete parameters such that the drive motor does not operate abnormally, and then provides the control value to the drive motor. In such a case, there is a possibility that the information processing apparatus 20 is not able to appropriately sample the output value of the black box function. In addition, since behavior of the drive motor changes with time due to sampling, a problem that an operation of the automobile is not stable may occur. However, even in such a case, the information processing apparatus 20 according to the present modified example can appropriately sample the output value of the black box function since the simulator 44 simulates the operation of the drive motor.

Furthermore, the simulator 44 can reflect the surrounding environment in the simulation by simulating the operation of the control target 100 using the sensor value output from the sensor that observes the control target 100. For example, in a case where the control target 100 is a drive motor of a vehicle, the simulator 44 can simulate an operation of the drive motor according to a road situation where the vehicle is traveling by acquiring a relationship between a rotational speed and a torque of the drive motor.

As described above, the information processing apparatus 20 according to the second modified example can appropriately control the control target 100 by the black box optimization even in an environment where the output value output from the black box function cannot be appropriately sampled based on the sample value output from the control target 100.

In a case of using the simulator 44, the optimization unit 28 may generate a plurality of sets of N discrete parameters by using different solution control parameters. For example, the optimization unit 28 generates two sets of N discrete parameters by using the solution control parameter having a high solution quality and a low calculation speed and the solution control parameter having a low solution quality and a high calculation speed. In this case, the simulator 44 acquires each of the plurality of sets of N discrete parameters, and simulates the operation of the control target 100 for each of the plurality of sets of N discrete parameters. Then, the sampling unit 32 samples the output value based on the simulation result for each of the plurality of sets of N discrete parameters. As a result, the information processing apparatus 20 can include a wide variety of different pieces of history data in the history data set, and can estimate the surrogate model accurately approximating the black box function and perform appropriate black box optimization control.

### Third Modified Example

Next, a third modified example of the control system 10 according to the first embodiment will be described.

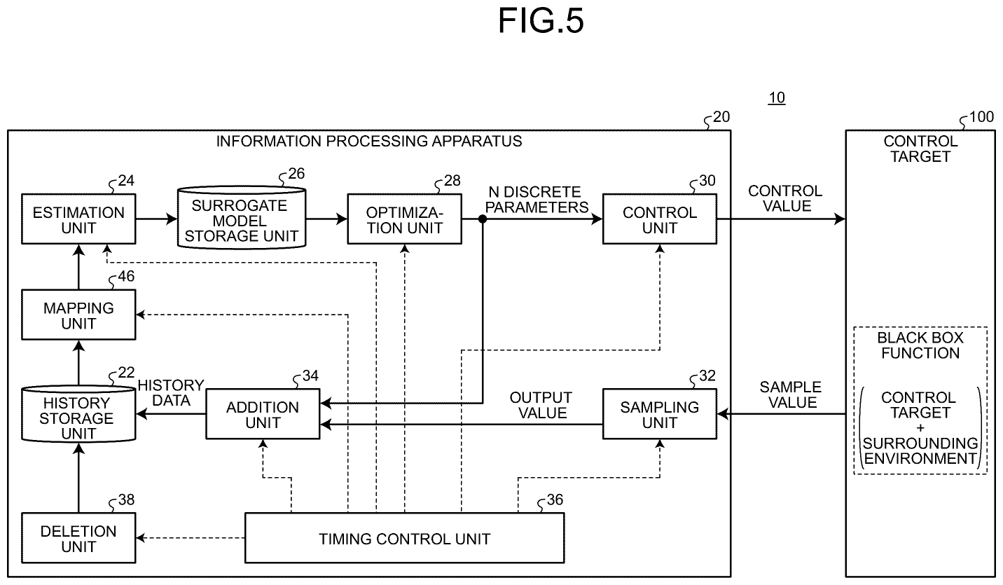

FIG. 5 is a diagram illustrating a configuration of a control system 10 according to the third modified example together with a control target 100.

In the third modified example, a control unit 30 generates a plurality of control values arranged in time series based on the N discrete parameters calculated by an optimization unit 28. Each of the plurality of control values corresponds to any discrete parameter of the N discrete parameters. Therefore, in the third modified example, the N discrete parameters are arranged in time series. Then, in the third modified example, the control unit 30 executes control processing of controlling the control target 100 according to the lapse of time based on the plurality of control values by providing the plurality of generated control values to the control target 100.

An information processing apparatus 20 according to the third modified example further includes a mapping unit 46.

The mapping unit 46 executes mapping processing of changing a correspondence relationship between the N discrete parameters included in the history data and the plurality of discrete variables in the surrogate model for each repetition in the black box optimization.

For example, the mapping unit 46 changes the correspondence relationship by changing information regarding association between the plurality of discrete variables in the surrogate model and the N discrete parameters included in the history data, each of the N discrete parameters being input to the plurality of discrete variables, respectively. Furthermore, the mapping unit 46 may change the correspondence relationship by changing a position of each of the plurality of discrete variables in the surrogate model in the functional form of the surrogate model. As a result, the mapping unit 46 can change the correspondence relationship between the N discrete parameters included in the history data and the plurality of discrete variables in the surrogate model while maintaining the coefficient in the surrogate model.

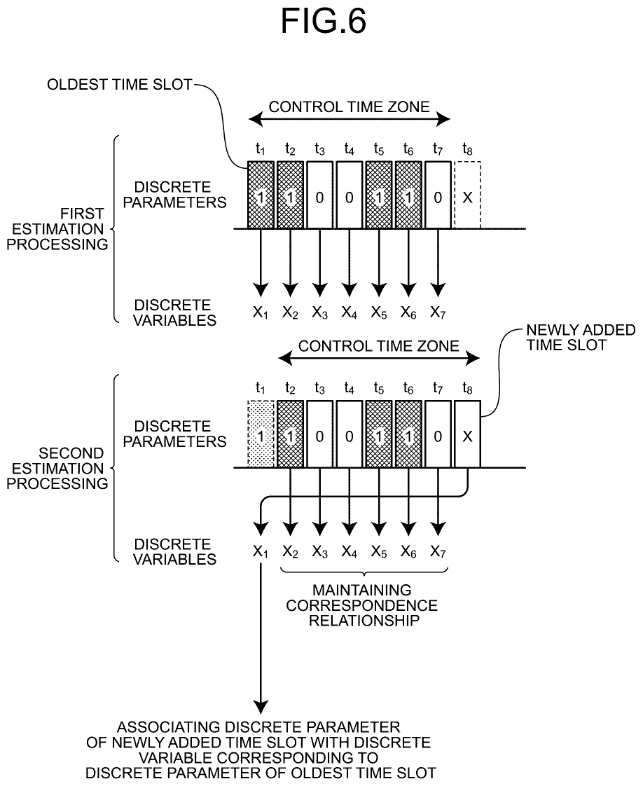

FIG. 6 is a diagram for describing the mapping processing in the mapping unit 46.

For example, it is assumed that the control target 100 is a drive motor of a vehicle. In addition, the plurality of control values correspond to a plurality of time slots obtained by time-dividing a certain control time zone on a one-to-one basis. The certain control time zone is, for example, a time zone from a control point in time such as the current time to a predetermined time such as 10 minutes later. Each of the plurality of control values is flag information indicating whether or not to rotate the drive motor in a corresponding time slot. In such a case, the control unit 30 controls whether or not to rotate the drive motor according to the control value of a time slot corresponding to the control point in time among the plurality of control values.

Here, in a case where the control target 100 is controlled in real time by, for example, the black box optimization, the information processing apparatus 20 repeatedly generates the N discrete parameters, for example, at regular time intervals. Then, the N discrete parameters cover different control time zones depending on a generation time. Therefore, the control time zones covered by the N discrete parameters are shifted as time passes. For example, in a case where the information processing apparatus 20 repeatedly generates the N discrete parameters for each time slot, the control time zone covered by the N discrete parameters calculated at a first time and the control time zone covered by the N discrete parameters calculated at a second time, which is one time slot after the first time, are shifted by one time slot. Each time such N discrete parameters are repeatedly generated, a discrete parameter corresponding to a new time slot is added, and a discrete parameter corresponding to the oldest time slot is deleted.

By the way, when optimization of the N discrete parameters by the black box optimization is sufficiently advanced, the discrete parameters corresponding to time slots other than the new time slot among the N discrete parameters are sufficiently optimized. Therefore, in the surrogate model, the coefficient to be multiplied by the discrete variable corresponding to the sufficiently optimized discrete parameter is preferably maintained. That is, in the surrogate model, even if the control time zone covered by the N discrete parameters is shifted, it is preferable that a relationship between the sufficiently optimized discrete parameter and the corresponding discrete variable is continuously maintained.

Therefore, the mapping unit 46 changes the correspondence relationship between the N discrete parameters included in the history data and the plurality of discrete variables in the surrogate model such that a time corresponding to a first discrete variable among the plurality of discrete variables in the surrogate model estimated in first estimation processing that is one of times of estimation processing repeatedly executed coincides with a time corresponding to a first discrete variable in the surrogate model estimated in second estimation processing that is estimation processing executed immediately after the first estimation processing.

For example, in the example of FIG. 6, the mapping unit 46 maps the correspondence relationship such that both a discrete variable of x₂ in the surrogate model estimated in the first estimation processing and a discrete variable of x₂ in the surrogate model estimated in the second estimation processing correspond to discrete parameters corresponding to a time slot of a time t₂. Furthermore, the mapping unit 46 similarly maps the correspondence relationship for a discrete variable of x₃ and a time slot of a time t₃, a discrete variable of x₄ and a time slot of a time t₄, a discrete variable of x₅ and a time slot of a time t₅, a discrete variable of x₆ and a time slot of a time to, and a discrete variable of x₇ and a time slot of a time t₇.

Then, the mapping unit 46 maps the correspondence relationship so as to associate a discrete parameter corresponding to a time slot of a time to newly added in the second estimation processing with a discrete variable of x₁ associated with a discrete parameter of a time slot of the oldest time t₁ in the first estimation processing. In this case, the mapping unit 46 may initialize a coefficient to be multiplied by a discrete variable (for example, x₁) corresponding to a time slot of a newly added time in the surrogate model to an initial value, a random value, or the like.

In this manner, the mapping unit 46 changes the correspondence relationship between the N discrete parameters included in the history data and the plurality of discrete variables in the surrogate model such that the time corresponding to the first discrete variable in the surrogate model estimated in the first estimation processing, which is one of the times of the estimation processing repeatedly executed, coincides with the time corresponding to the first discrete variable in the surrogate model estimated in the second estimation processing. As a result, the mapping unit 46 can maintain the coefficient to be multiplied by the discrete variable corresponding to the sufficiently optimized discrete parameter in the surrogate model.

In a case where a time interval of the time slots is different from a calculation interval of the N discrete parameters, any one of the plurality of discrete variables may have no corresponding discrete parameter. In such a case, the mapping unit 46 may generate and associate a flag indicating that a corresponding discrete parameter does not exist, a dummy value, or a value interpolated from an immediately preceding discrete parameter or a surrounding discrete parameter with respect to the discrete variable having no corresponding discrete parameter. Furthermore, in a case where no discrete parameter corresponds to a time slot in the history data, the mapping unit 46 may substitute a flag indicating that no discrete parameter corresponds to the discrete parameter of the history data, a dummy value, or a value interpolated from an immediately preceding discrete parameter or a surrounding discrete parameter.

### Fourth Modified Example

Next, a fourth modified example of the control system 10 according to the first embodiment will be described.

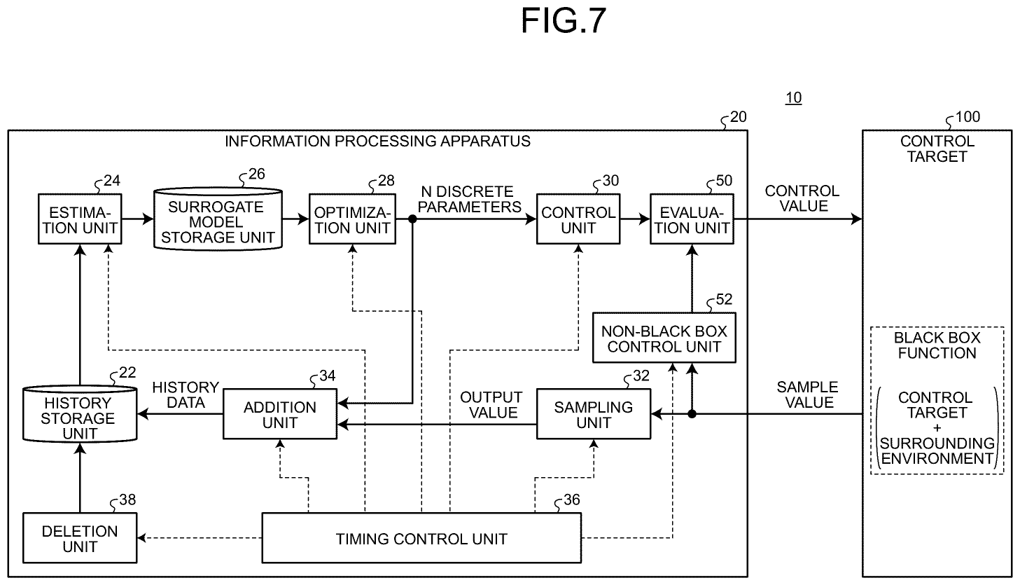

FIG. 7 is a diagram illustrating a configuration of a control system 10 according to the fourth modified example together with a control target 100.

An information processing apparatus 20 according to the fourth modified example further includes an evaluation unit 50 and a non-black box control unit 52.

The evaluation unit 50 executes evaluation processing of evaluating whether or not a control value generated by a control unit 30 based on the N discrete parameters satisfies a predetermined evaluation criterion. For example, the evaluation unit 50 may evaluate whether or not the control value satisfies the evaluation criterion by substituting the N discrete parameters that are the basis of the control value into the surrogate model generated by an estimation unit 24. In this case, the evaluation unit 50 determines whether or not an evaluation value calculated by the surrogate model satisfies the predetermined evaluation criterion.

Furthermore, the evaluation unit 50 may determine whether or not the predetermined evaluation criterion is satisfied by a model different from the surrogate model, or may determine whether or not the control target 100 performs an operation that satisfies the predetermined evaluation criterion by simulating the operation of the control target 100 when the control value is provided.

In a case where the control value satisfies the predetermined evaluation criterion, the evaluation unit 50 provides the control value generated based on the N discrete parameters to the control target 100. In a case where the control value does not satisfy the predetermined evaluation criterion, the evaluation unit 50 provides the control value generated based on information different from the N discrete parameters to the control target 100 instead of the control value generated based on the N discrete parameters.

In the present modified example, in a case where the control value generated based on the N discrete parameters does not satisfy the predetermined evaluation criterion, the evaluation unit 50 provides the control value generated by the non-black box control unit 52 to the control target 100. The non-black box control unit 52 generates the control value for controlling the control target 100 by non-black box control processing. For example, the non-black box control unit 52 generates the control value for performing the PID control or the control based on the optimal control theory based on a sample value output from a sensor that observes the control target 100.

In a case of performing the black box optimization control on the control target 100, the information processing apparatus 20 according to the fourth modified example can avoid an operation that deteriorates the control target 100 beyond the predetermined evaluation criterion, for example, an operation that impairs safety or comfort, and can perform control more stably.

### Fifth Modified Example

Next, a fifth modified example of the control system 10 according to the first embodiment will be described.

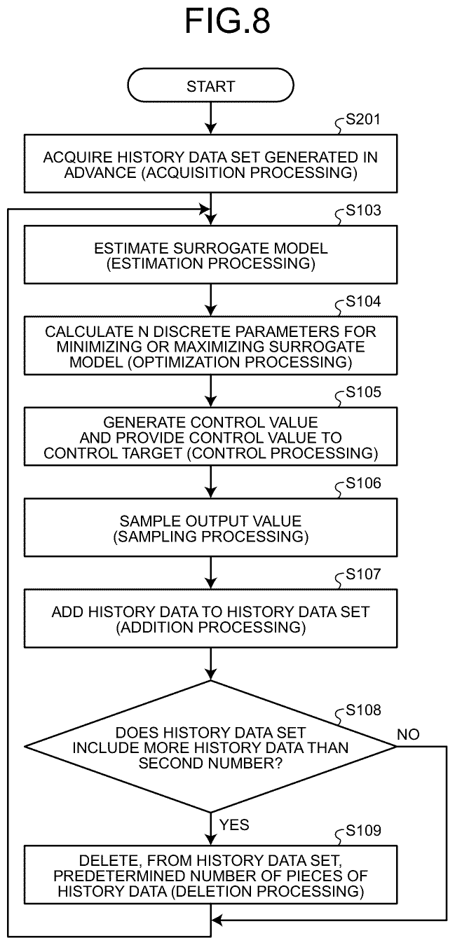

FIG. 8 is a flowchart illustrating a flow of processing in an information processing apparatus 20 according to the fifth modified example.

In a case where control of a control target 100 is started, the information processing apparatus 20 executes processing in the flow illustrated in FIG. 8.

First, in S201, before first estimation processing, the information processing apparatus 20 executes acquisition processing of acquiring the history data set generated in advance and storing the acquired history data set in a history storage unit 22. The history data set generated in advance includes at least a first number or more of history data sets. The history data set generated in advance includes, for example, the history data registered in advance at the time of factory shipment. The history data set generated in advance includes, for example, highly versatile history data that can cope with many situations based on an assumption of a normal use situation.

After completing the processing of S201, the information processing apparatus 20 advances the processing to S103. The information processing apparatus 20 executes the same processing as the processing described in FIG. 2 in the processing from S103 to S109. Then, in a case where the information processing apparatus 20 determines that the number of pieces of history data included in the history data set is not larger than a second number in S108 (No in S108) or in a case where the processing in S109 is ended, the processing returns to S103.

For example, in a case where the control value is generated based on the N discrete parameters randomly generated at the start of control, the information processing apparatus 20 generates a low quality control value, and may cause the control target 100 to perform an operation that impairs, for example, safety or comfort. In the present modified example, since the information processing apparatus 20 generates the surrogate model by using the history data set generated in advance at the start of control, for example, it is possible to provide, to the control target 100, the control value with a low possibility of causing the operation that impairs safety or comfort.

The information processing apparatus 20 may acquire, for example, the history data set at the end of the previous control as the history data set generated in advance. In this case, the black box optimization control can be performed by taking over the surrogate model generated in the previous environment immediately after the start of control, and deterioration in quality of the control immediately after the start of the control can be suppressed.

The information processing apparatus 20 may use a surrogate model generated in advance instead of the history data set generated in advance. The surrogate model generated in advance may be registered in advance at the time of factory shipment, for example. The surrogate model generated in advance is, for example, a highly versatile surrogate model that can cope with many situations based on an assumption of a normal use situation. The surrogate model generated in advance is input to an estimation unit 24 together with a newly added history data set, and gradually changes to a surrogate model inferred based on a sampling result by repeating the estimation processing. The estimation processing may be so-called online machine learning in which the surrogate model is sequentially updated by the input history data. Furthermore, the surrogate model generated in advance may be a surrogate model at the end of the previous control. Therefore, the information processing apparatus 20 can reduce a possibility of performing low quality control at the start of control.

### Sixth Modified Example

Next, a sixth modified example of the control system 10 according to the first embodiment will be described.

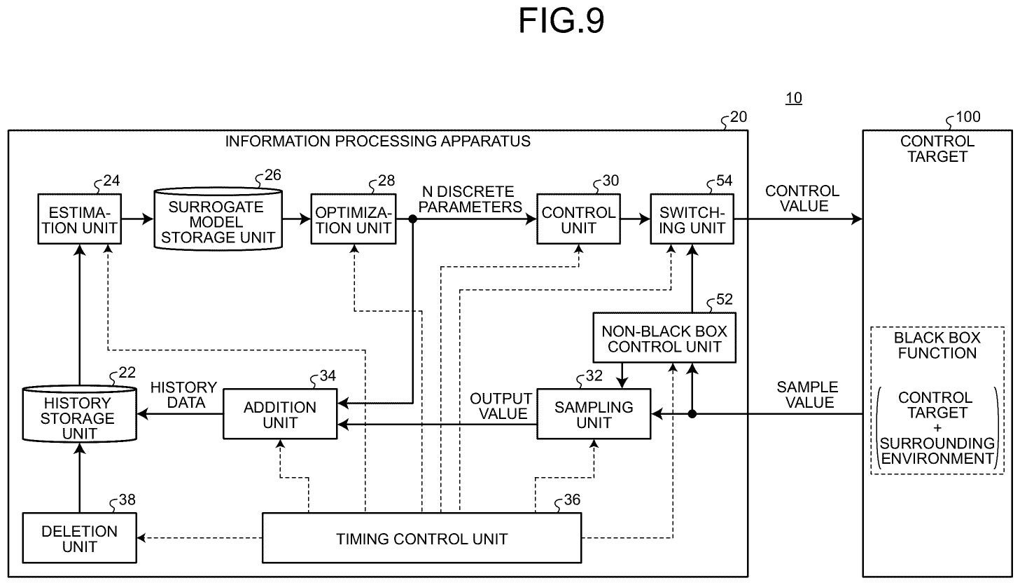

FIG. 9 is a diagram illustrating a configuration of a control system 10 according to a sixth modified example together with a control target 100.

An information processing apparatus 20 according to the sixth modified example includes a non-black box control unit 52 and switching unit 54.

The switching unit 54 provides the control value generated by the non-black box control unit 52 to the control target 100 in a predetermined initial period after the start of control. After the predetermined period ends, the switching unit 54 provides the control value generated by a control unit 30 based on the N discrete parameters to the control target 100.

For example, the switching unit 54 may provide the control value generated by the non-black box control unit 52 to the control target 100 until a predetermined number or more of pieces of history data are sampled, and provide the control value generated by the control unit 30 based on the N discrete parameters to the control target 100 after the predetermined number or more of pieces of history data are sampled. Furthermore, for example, the switching unit 54 may provide the control value generated by the non-black box control unit 52 to the control target 100 until a predetermined time elapses from the start of control, and may provide the control value generated by the control unit 30 based on the N discrete parameters to the control target 100 after the predetermined time elapses from the start of the control.

Furthermore, in a period in which the control value generated by the non-black box control unit 52 is provided to the control target 100, a sampling unit 32 calculates the N discrete parameters based on the control value provided to the control target 100, and provides the calculated N discrete parameters to an addition unit 34. As a result, the addition unit 34 can sample the history data including the N discrete parameters and the output value and add the history data to the history data set in the period in which the control value generated by the non-black box control unit 52 is provided to the control target 100.

In a case where the control value is generated based on the N discrete parameters randomly generated at the start of control, the information processing apparatus 20 generates a low quality control value, and may cause the control target 100 to perform an operation that impairs, for example, safety or comfort. In the present modified example, the information processing apparatus 20 can control the control target 100 by a technically mature control method with high versatility in the predetermined initial period after the start of control. As a result, the information processing apparatus 20 can provide, to the control target 100, the control value with a low possibility of causing, for example, the operation that impairs safety or comfort in the predetermined initial period after the start of control.

### Seventh Modified Example

Next, a seventh modified example of the control system 10 according to the first embodiment will be described.

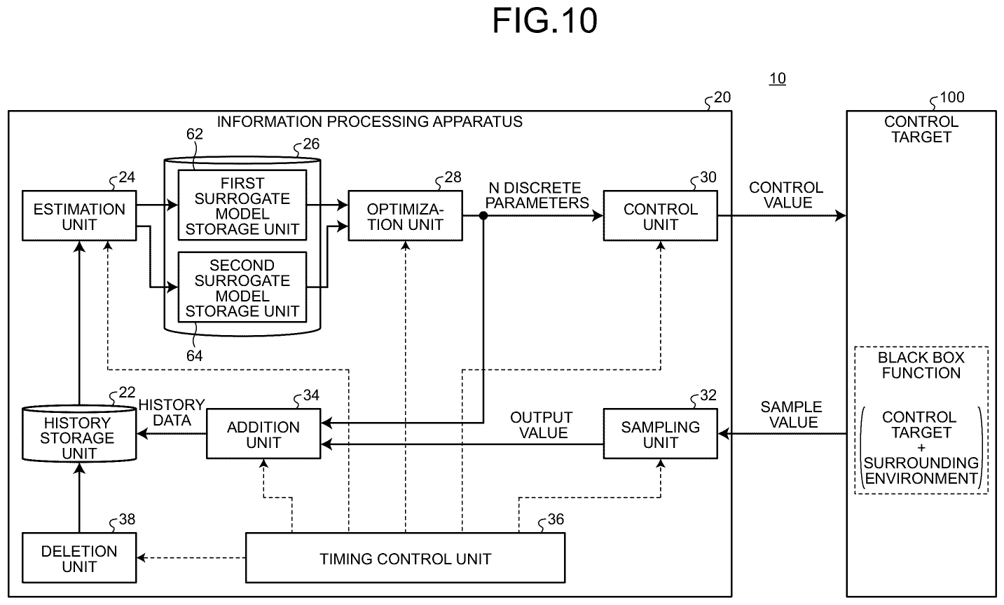

FIG. 10 is a diagram illustrating a configuration of a control system 10 according to a seventh modified example together with a control target 100.

A surrogate model storage unit 26 according to the seventh modified example includes a first surrogate model storage unit 62 and a second surrogate model storage unit 64.

The first surrogate model storage unit 62 stores a first surrogate model which is the surrogate model.

The second surrogate model storage unit 64 stores a second surrogate model which is the surrogate model. The second surrogate model is smaller in size than the first surrogate model. That is, the second surrogate model is represented by a functional form in which the number of included coefficients, that is, the number of terms is smaller than that of the first surrogate model.

The small-sized surrogate model can reduce the number of pieces of history data required for estimation. Therefore, the small-sized surrogate model accurately approximates the black box function at a stage where the number of pieces of history data included in the history data set is small. On the other hand, the large-sized surrogate model more accurately approximates the black box function than the small-sized surrogate model in a case where the number of pieces of history data included in the history data set is sufficiently large.

Here, the accuracy represents a low error when the surrogate model approximates the black box function. The surrogate model does not need to achieve approximation with high accuracy over the entire domain of the black box function, and only needs to achieve approximation with high accuracy around a value of interest.

An optimization unit 28 calculates a solution to the optimization problem by using any one of the first surrogate model or the second surrogate model as the surrogate model. In the present modified example, the optimization unit 28 determines which one of the first surrogate model and the second surrogate model is used according to the number of pieces of history data included in the history data set. For example, in a case where the number of pieces of history data included in the history data set is smaller than a predetermined number, the optimization unit 28 calculates the solution to the optimization problem by using the second surrogate model as the surrogate model. For example, in a case where the number of pieces of history data included in the history data set is equal to or larger than the predetermined number, the optimization unit 28 calculates the solution to the optimization problem by using the first surrogate model as the surrogate model.

An information processing apparatus 20 according to the seventh modified example can perform the black box optimization control by using the small-sized surrogate model at a stage where the number of pieces of history data included in the history data set is small, and using the large-size surrogate model at a stage where the number of pieces of history data included in the history data set is sufficiently large. As a result, the information processing apparatus 20 according to the seventh modified example can accurately control the control target 100 regardless of the number of pieces of history data included in the history data set.

### Eighth Modified Example

Next, an eighth modified example of the control system 10 according to the first embodiment will be described.

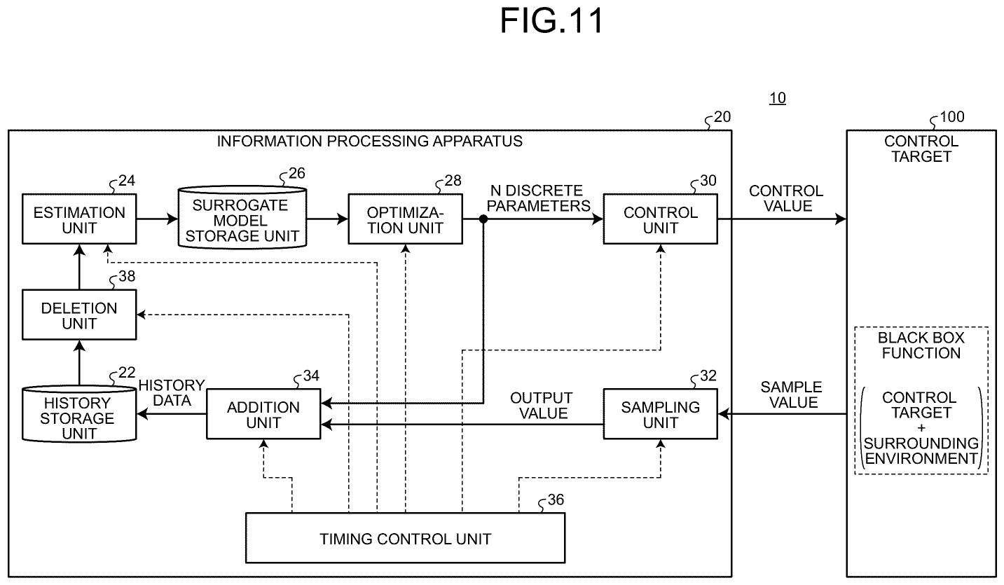

FIG. 11 is a diagram illustrating a configuration of a control system 10 according to the eighth modified example together with a control target 100.

In the eighth modified example, a deletion unit 38 is provided between a history storage unit 22 and an estimation unit 24. In this case, at a stage of delivering the history data set to the estimation unit 24, the deletion unit 38 deletes, from the history data set, at least some of pieces of history data added in addition processing executed a predetermined number of times earlier or executed a predetermined time earlier, and delivers the history data set to the estimation unit 24.

The deletion unit 38 does not delete the history data set stored in the history storage unit 22. Therefore, in a case where the history data set includes more history data than a predetermined number, the deletion unit 38 executes processing corresponding to selection processing of selecting a predetermined number of pieces of history data from the history data set stored in the history storage unit 22 and providing the history data set including the selected predetermined number of pieces of history data to the estimation unit 24.

In this case, the deletion unit 38 preferentially selects the later history data in the history data set. That is, the deletion unit 38 preferentially selects the history data added later than the history data added earlier. That is, the deletion unit 38 preferentially selects new history data over old history data.

For example, before the estimation unit 24 executes estimation processing, the deletion unit 38 determines whether or not the history data set includes more history data than the predetermined number, and selects, in a case where the history data set includes more history data than the predetermined number, a predetermined number of pieces of history data in order, starting from the history data added later. In a case where the history data set does not include more history data than the predetermined number, the deletion unit 38 does not have to perform the selection of the history data.

By executing such processing, the deletion unit 38 can provide, to the estimation unit 24, the history data set including the predetermined number of pieces of history data added later.

The deletion unit 38 may set specific history data included in the history data set as fixed history data and select the fixed history data even if the fixed history data is before history data preceding a predetermined order. As a result, the deletion unit 38 can provide the history data set including the specific history data to the estimation unit 24.

In a case where a time is added to the history data, for example, the deletion unit 38 may select history data of a time later than a predetermined time in the history data set.

In this case, the deletion unit 38 may also set the specific history data included in the history data set as the fixed history data, and select the fixed history data even if the fixed history data is history data before a predetermined time.

An information processing apparatus 20 according to such a modified example can obtain a similar effect to a case of deleting some pieces of history data from the history data set stored in the history storage unit 22. That is, the information processing apparatus 20 according to the present modified example can estimate the surrogate model by using the most recently added history data without using relatively old history data. As a result, with the information processing apparatus 20 according to the present modified example, the black box function can be accurately optimized with a small number of samplings. Therefore, with the information processing apparatus 20 according to the present modified example, for example, the control by the black box optimization can be performed with high responsiveness and accuracy for the dynamically changing control target 100.

### Second Embodiment

Next, a vehicle control system 200 according to a second embodiment will be described.

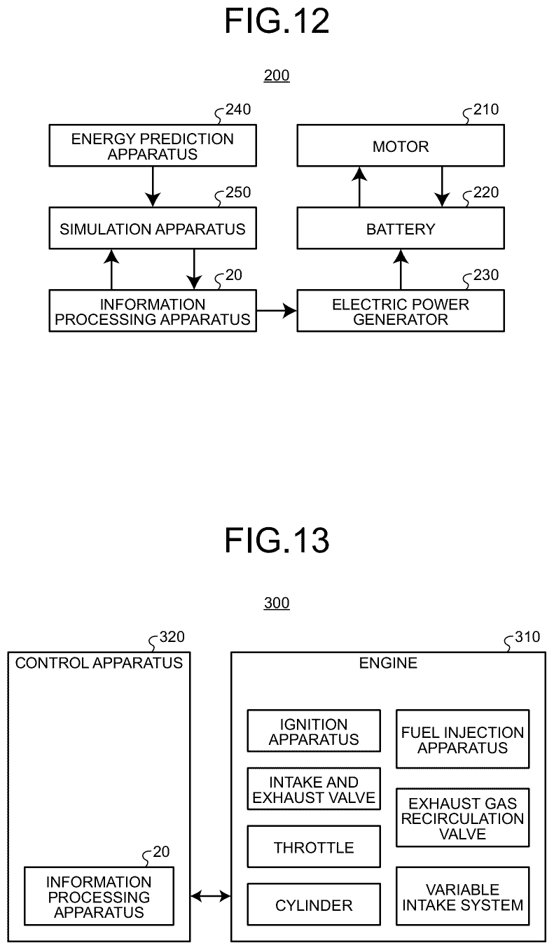

FIG. 12 is a diagram illustrating a configuration of the vehicle control system 200 according to the second embodiment. The vehicle control system 200 according to the second embodiment is a system that controls a series hybrid type vehicle, the system including the information processing apparatus 20 according to the first embodiment described with reference to FIGS. 1 to 11.

The vehicle control system 200 includes a motor 210, a battery 220, an electric power generator 230, an energy prediction apparatus 240, a simulation apparatus 250, and the information processing apparatus 20.

The motor 210 rotates wheels of the vehicle based on electric power supplied from the battery 220 to cause the vehicle to travel.

The battery 220 stores the electric power supplied from the electric power generator 230. The battery 220 supplies the electric power to the motor 210. Further, the battery 220 stores the regenerated electric power generated by the rotation of the motor 210.

The electric power generator 230 converts fuel into the electric power and supplies the electric power to the battery 220.

The energy prediction apparatus 240 calculates a planned travel route on which the vehicle is planned to travel, and predicts an energy consumption in a case where the vehicle travels according to the calculated predicted travel route. The energy prediction apparatus 240 is, for example, a car navigation apparatus, and calculates a route from a current position to a destination position of the vehicle as a planned travel route. Furthermore, the energy prediction apparatus 240 calculates, for example, the energy consumption for each predetermined time unit in a case where the vehicle travels on the planned travel route based on a gradient of a road surface, a curvature of a curve, an average speed, a state of a signal, and the like in the planned travel route.

The simulation apparatus 250 simulates a time transition of a remaining level of the battery 220 in a case where the vehicle travels according to the planned travel route based on a time-series on/off pattern of the electric power generator 230 and the energy consumption predicted by the energy prediction apparatus 240. The simulation apparatus 250 may be a simulator 44 implemented by the information processing apparatus 20.

The information processing apparatus 20 generates, for example, a plurality of control values arranged in time series. In the present embodiment, the plurality of control values are the time-series on/off pattern of the electric power generator 230.

More specifically, in estimation processing, the information processing apparatus 20 estimates the surrogate model obtained by modeling the black box function in which the output value is the time transition of the remaining level of the battery 220. In sampling processing, the information processing apparatus 20 provides the N discrete parameters to the simulation apparatus 250, and samples a simulation result of the simulation apparatus 250 as the output value. Then, in control processing, the information processing apparatus 20 generates the plurality of control values arranged in time series for controlling the electric power generator 230 in time series.

In the series hybrid type vehicle, the electric power is exchanged between the electric power generator 230 and the battery 220 and between the battery 220 and the motor 210. An instantaneous amount of electric power exchanged between the battery 220 and the motor 210 is determined by an operation by a driver, the gradient of the road surface, the speed, and the like. Such an amount of electric power is a continuous value. The energy prediction apparatus 240 predicts a temporal change of the amount of electric power.

The electric power generator 230 provided in the series hybrid type vehicle can always operate with a highly efficient parameter. Therefore, the series hybrid type vehicle can control the electric power generator 230 to be turned on or off. Therefore, in the present embodiment, the information processing apparatus 20 generates the time-series on/off pattern of the electric power generator 230 as the plurality of control values. The information processing apparatus 20 may generate a pattern in which quantized rotational speed values are arranged in time series as the plurality of control values.

In order to prevent a state of shortening a life of the battery 220, the vehicle on which the battery 220 is mounted may limit the remaining level of the battery 220 such that the remaining level of the battery 220 falls within a set range. In a case where such limitation is applied, the battery 220 cannot store the electric power regenerated from the motor 210 in a state where the remaining level reaches an upper limit of the set range. In addition, in a case where such a limitation is applied, in the motor 210, a rotational force of the motor 210 falls below a required level in a state where the remaining level reaches a lower limit of the set range.

In the present embodiment, the information processing apparatus 20 controls the black box optimization by using the surrogate model obtained by modeling the black box function in which the output value is the time transition of the remaining level of the battery 220. Therefore, the information processing apparatus 20 can control the electric power generator 230 such that the remaining level of the battery 220 does not reach the upper limit of the set range and the lower limit of the set range. Therefore, in the present embodiment, the information processing apparatus 20 can more easily recover the regenerated electric power by lowering the remaining level of the battery 220 and can avoid shortage of the rotational force of the motor 210 by increasing the remaining level of the battery 220 in advance, based on a temporal change of a predicted amount of electric power. Furthermore, the information processing apparatus 20 can reduce an output of the electric power generator 230 by reducing a frequency at which the shortage of the rotational force of the motor 210 occurs.

### Third Embodiment

Next, a moving body control system 300 according to a third embodiment will be described.

FIG. 13 is a diagram illustrating a configuration of the moving body control system 300 according to the third embodiment. The moving body control system 300 according to the third embodiment is a system that controls a moving body such as a vehicle, the system including the information processing apparatus 20 according to the first embodiment described with reference to FIGS. 1 to 11.

The moving body control system 300 includes an engine 310 and a control apparatus 320.

The engine 310 consumes fuel to move the moving body. The engine 310 includes, for example, an ignition apparatus, an intake and exhaust valve, a throttle, a cylinder, a fuel injection apparatus, an exhaust gas recirculation valve, a variable intake system, and the like.

The control apparatus 320 includes the information processing apparatus 20 and controls the engine 310. The control apparatus 320 controls, for example, at least one of the ignition apparatus, the intake and exhaust valve, the throttle, the cylinder, the exhaust gas recirculation valve, and the variable intake system in the engine 310.

In the present embodiment, in estimation processing, the information processing apparatus 20 estimates the surrogate model obtained by modeling the black box function in which the output value is at least one of vibration, noise, and a gas emission amount of the moving body. In sampling processing, the information processing apparatus 20 samples the output value based on a sensor value detected by a sensor that observes a vehicle body or the engine 310. Then, in control processing, the information processing apparatus 20 generates a control value for controlling the engine 310 based on the N discrete parameters.

Some of the ignition apparatus, the intake and exhaust valve, the throttle, the cylinder, the exhaust gas recirculation valve, and the variable intake system in the engine 310 are periodically controlled. For example, an ignition timing of the ignition apparatus, opening/closing of the intake and exhaust valve, and a fuel injection timing of the throttle are periodically controlled based on a crank angle. The crank angle is a continuous value, but is represented by a discrete variable expressed in stages. A stage of the expression of the crank angle may or may not be each certain angle.

Control parameters of some of the ignition apparatus, the intake and exhaust valve, the throttle, the cylinder, the exhaust gas recirculation valve, and the variable intake system in the engine 310 are represented by modes. For example, an opening degree of the throttle, a fuel injection pattern, an opening degree of the exhaust gas recirculation valve, and opening and closing of a valve of the variable intake system may be selected from a plurality of preset setting values according to the mode. As control is performed according to such a setting value, the information processing apparatus 20 can generate the control value of the engine 310 based on the N discrete parameters.

Then, in the present embodiment, the information processing apparatus 20 estimates the surrogate model obtained by modeling the black box function in which the output value is at least one of the vibration, the noise, and the gas emission amount of the moving body. As a result, the moving body control system 300 according to the present embodiment can control the engine 310 so as to optimize at least one of the vibration, the noise, and the gas emission amount of the moving body. For example, the moving body control system 300 according to the present embodiment can optimize a fuel consumption, the vibration, the noise, a CO₂ emission amount, a CO emission amount, a PM emission amount, a NOx emission amount, and a combination thereof.

### Fourth Embodiment

Next, a moving body control system 400 according to a fourth embodiment will be described.

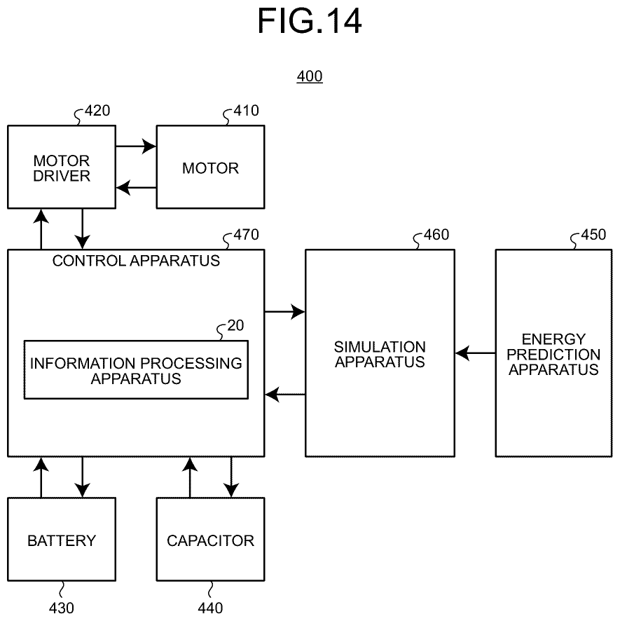

FIG. 14 is a diagram illustrating a configuration of the moving body control system 400 according to the fourth embodiment. The moving body control system 400 according to the fourth embodiment is a system that controls a moving body such as a vehicle, the system including the information processing apparatus 20 according to the first embodiment described with reference to FIGS. 1 to 11.

The moving body control system 400 includes a motor 410, a motor driver 420, a battery 430, a capacitor 440, an energy prediction apparatus 450, a simulation apparatus 460, and a control apparatus 470.

The motor 410 moves the moving body. The motor driver 420 drives the motor 410 based on electric power supplied from the battery 430 and the capacitor 440.

The battery 430 is an example of a first electric power storage apparatus, and stores the electric power. The battery 430 supplies the electric power to the motor driver 420. Further, the battery 430 stores the electric power regenerated from the motor driver 420.

The capacitor 440 is an example of a second electric power storage apparatus having characteristics different from those of the first electric power storage apparatus, and stores the electric power. The capacitor 440 is different from the battery 430 as the first electric power storage apparatus in charging and discharging characteristics, aging characteristics, and capacity. For example, the degree of aging of the capacitor 440 according to the number of times of charging and discharging is lower than that of the battery 430. The capacitor 440 supplies the electric power to the motor driver 420. Further, the capacitor 440 stores the electric power regenerated from the motor driver 420.

The energy prediction apparatus 450 calculates a planned movement route on which the moving body is planned to move, and predicts an energy consumption in a case where the moving body moves according to the calculated predicted movement route. The energy prediction apparatus 450 is, for example, a car navigation apparatus, and calculates a route from a current position to a destination position of the moving body as the planned movement route. Furthermore, the energy prediction apparatus 450 calculates, for example, the energy consumption for each predetermined time unit in a case where the moving body moves along the planned movement route based on a gradient of a road surface, a curvature of a curve, an average speed, a state of a signal, and the like in the planned movement route.

The simulation apparatus 460 simulates a state of the battery 430 in a case where the moving body moves according to the planned movement route based on an electric power input/output pattern between the motor driver 420 and the battery 430, an electric power input/output pattern between the motor driver 420 and the capacitor 440, and the energy consumption predicted by the energy prediction apparatus 450. In the present embodiment, the simulation apparatus 460 simulates the number of times of charging and discharging of the battery 430. The simulation apparatus 460 may be a simulator 44 implemented by the information processing apparatus 20.

The control apparatus 470 includes the information processing apparatus 20, and controls input and output of the electric power between the motor driver 420 and the battery 430 and input and output of the electric power between the motor driver 420 and the capacitor 440.

The information processing apparatus 20 generates, for example, a plurality of control values arranged in time series. In the present embodiment, the plurality of control values are a time-series pattern of the input and output of the electric power between the motor driver 420 and the battery 430 and a time-series pattern of the input and output of the electric power between the motor driver 420 and the capacitor 440.

More specifically, in estimation processing, the information processing apparatus 20 estimates the surrogate model obtained by modeling the black box function in which the output values are a time transition of a remaining level of the battery 430 and a time transition of a remaining amount of the capacitor 440. Furthermore, in sampling processing, the information processing apparatus 20 provides the N discrete parameters to the simulation apparatus 250, and samples a simulation result of the simulation apparatus 250 as the output value. Then, in control processing, the information processing apparatus 20 generates the plurality of control values arranged in time series for controlling the input and output of the electric power between the motor driver 420 and the battery 430 and the input and output of the electric power between the motor driver 420 and the capacitor 440 in time series.

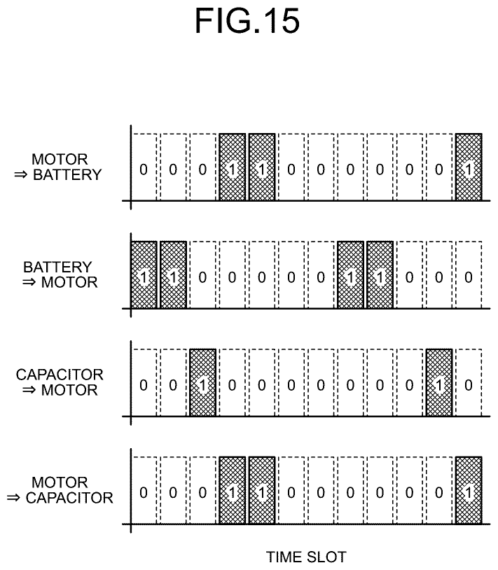

FIG. 15 is a diagram illustrating an example of the time-series pattern of the input and output of the electric power between the motor driver 420 and the battery 430 and the input and output of the electric power between the motor driver 420 and the capacitor 440.

The information processing apparatus 20 generates, for each time slot, a time-series pattern of movement of the electric power from the motor driver 420 to the battery 430, a time-series pattern of movement of the electric power from the battery 430 to the motor driver 420, a time-series pattern of movement of the electric power from the capacitor 440 to the motor driver 420, and a time-series pattern of movement of the electric power from the motor driver 420 to the capacitor 440 as the plurality of control values arranged in time series. The example of FIG. 15 illustrates that the electric power is input and output in a time slot having a value of 1, and the electric power is not input and output in a time slot having a value of 0.

Then, in the present embodiment, the information processing apparatus 20 generates the plurality of control values arranged in time series so as to minimize the number of times of charging and discharging of the battery 430. The battery 430 experiences greater deterioration due to charging and discharging compared to the capacitor 440. In the present embodiment, the information processing apparatus 20 can prevent the deterioration of the battery 430 by minimizing the number of times of charging and discharging of the battery 430.

The simulation apparatus 460 may simulate an evaluation value indicating whether or not a torque required by the motor 410 in a case where the moving body moves according to the planned movement route is sufficient. In this case, in the estimation processing, the information processing apparatus 20 estimates the surrogate model obtained by modeling the black box function in which the output value is the evaluation value indicating whether or not the torque required by the motor 410 is sufficient. In addition, the simulation apparatus 460 may simulate a total electric power consumption in a case where the moving body moves along the planned movement route or an amount of electric power that is not regenerated. In this case, in the estimation processing, the information processing apparatus 20 estimates the surrogate model obtained by modeling the black box function in which the output value is the evaluation value indicating the total electric power consumption or the amount of electric power that is not regenerated.

In addition, the simulation apparatus 460 may simulate the evaluation value obtained by combining two or more of the number of times of charging and discharging of the battery 430, the total electric power consumption, and the amount of electric power that is not regenerated. Then, in this case, in the estimation processing, the information processing apparatus 20 estimates the surrogate model obtained by modeling the black box function in which the output value is such an evaluation value.

For example, in a case where the evaluation value indicating whether or not the torque required by the motor 410 is sufficient is simulated, the information processing apparatus 20 can cause both the battery 430 and the capacitor 440 to simultaneously output the electric power, and can increase a maximum amount of electric power to be supplied to the motor 410 as compared with a case where the electric power is output only from the battery 430. In addition, in a case where the total energy consumption or the amount of energy that is not regenerated is simulated, the information processing apparatus 20 can minimize a total amount of energy discharged by the battery 430 and reduce the electric power consumption.

The moving body control system 400 according to the present embodiment includes the battery 430 as an example of the first electric power storage apparatus, and includes the capacitor 440 as an example of the second electric power storage apparatus. However, the moving body control system 400 may include, as examples of the first electric power storage apparatus and the second electric power storage apparatus, a set of two or more types of electric power storage apparatuses having different life characteristics or different charging and discharging characteristics, instead of a set of the battery 430 and the capacitor 440.

### Fifth Embodiment

Next, a power system 500 according to a fifth embodiment will be described.

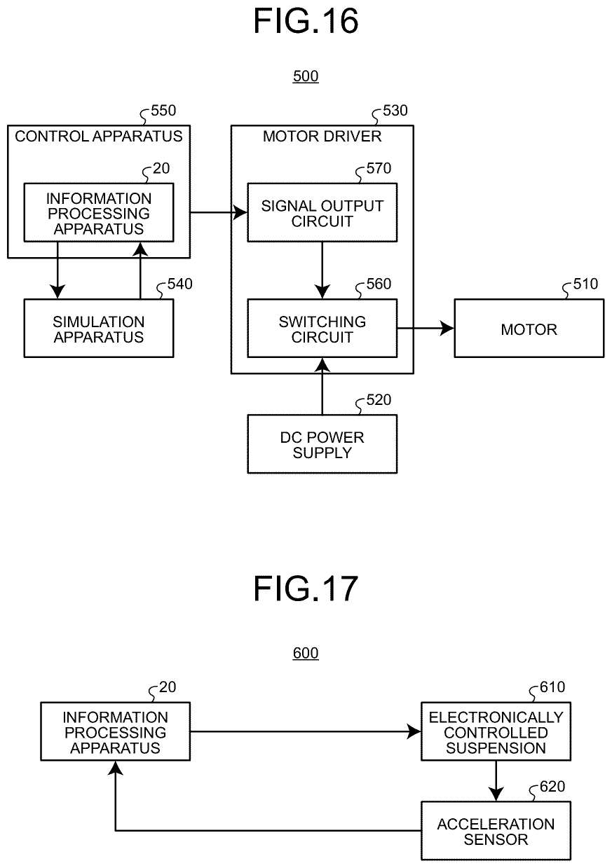

FIG. 16 is a diagram illustrating a configuration of the power system 500 according to the fifth embodiment. The power system 500 according to the fifth embodiment is a system that controls a rotating device, the system including the information processing apparatus 20 according to the first embodiment described with reference to FIGS. 1 to 11.

The power system 500 includes a motor 510, a direct current (DC) power supply 520, a motor driver 530, a simulation apparatus 540, and a control apparatus 550.

The motor 510 operates a machine or the like.

The DC power supply 520 generates a DC power supply voltage. For example, the DC power supply 520 generates a positive-side power supply voltage and a negative-side power supply voltage.

The motor driver 530 drives the motor 510 based on electric power supplied from the DC power supply 520.

The motor driver 530 includes a switching circuit 560 and a signal output circuit 570. The switching circuit 560 switches and supplies the positive-side power supply voltage or the negative-side power supply voltage to the motor 510 according to a signal output from the signal output circuit 570. For example, the switching circuit 560 is an inverter.

The signal output circuit 570 outputs a pulse width modulation (PWM) control signal for PWM control of the switching circuit 560.

The simulation apparatus 540 simulates an electric power loss of the power system 500 based on a pattern of the PWM control signal supplied to the switching circuit 560. The simulation apparatus 540 may be a simulator 44 implemented by the information processing apparatus 20.

The control apparatus 550 includes the information processing apparatus 20 and controls the motor driver 530.

The information processing apparatus 20 generates, for example, a plurality of control values arranged in time series. In the present embodiment, the plurality of control values are a control pattern of the PWM control signal for switching the switching circuit 560.

More specifically, in estimation processing, the information processing apparatus 20 estimates the surrogate model obtained by modeling the black box function in which the output value is the electric power loss of the power system 500. Furthermore, in sampling processing, the information processing apparatus 20 provides the N discrete parameters to the simulation apparatus 540, and samples a simulation result of the simulation apparatus 540 as the output value. Then, in control processing, the information processing apparatus 20 generates the plurality of control values arranged in time series for controlling the PWM control signal in the motor driver 530 in time series. The simulation apparatus 540 may receive a rotational speed and a torque required for the motor. Furthermore, the simulation apparatus 540 may acquire the values by a sensor.

In the present embodiment, the information processing apparatus 20 generates the plurality of control values arranged in time series so as to minimize the electric power loss of the power system 500. The electric power loss of the power system 500 is, for example, an iron loss or a copper loss in the motor 510, a switching loss in the switching circuit 560, and an on loss in the switching circuit 560. In general, the smaller the number of switching operations of the switching circuit 560, the smaller the loss. On the other hand, the switching circuit 560 can more effectively suppress ripple with relatively more frequent switching.

In the present embodiment, the motor driver 530 generates an on/off pattern of the switching circuit 560 in units of time slots obtained by division into periods that are the same as or shorter than a minimum switching period. The simulation apparatus 540 repeatedly calculates the electric power loss of the power system 500 based on the pattern of the PWM control signal supplied to the switching circuit 560. As a result, the information processing apparatus 20 can generate the plurality of control values arranged in time series for generating the PWM control signal that minimizes the electric power loss.

Furthermore, the information processing apparatus 20 can generate the PWM control signal in the motor driver 530 so as to suppress the electric power loss of the power system 500 even if an environment such as the required torque, the required rotational speed, and an input voltage changes.

The simulation apparatus 540 may simulate the degree of matching with a target torque, the degree of matching with a target rotational speed, or the like, instead of the electric power loss of the power system 500. In this case, in the estimation processing, the information processing apparatus 20 estimates the surrogate model obtained by modeling the black box function in which the output value is the degree of matching with the target torque or the degree of matching with the target rotational speed. Such an information processing apparatus 20 can generate the PWM control signal in the motor driver 530 such that the target torque or the target rotational speed matches a target value.

In addition, the simulation apparatus 540 may simulate a temperature of the motor 510 or the switching circuit 560 instead of the electric power loss of the power system 500. In this case, in the estimation processing, the information processing apparatus 20 estimates the surrogate model obtained by modeling the black box function in which the output value is the temperature. Such an information processing apparatus 20 can generate the PWM control signal in the motor driver 530 so as to minimize the temperature of the motor 510 or the switching circuit 560.

### Sixth Embodiment

Next, a suspension control system 600 according to a sixth embodiment will be described.

FIG. 17 is a diagram illustrating a configuration of a suspension control system 600 according to a sixth embodiment. The suspension control system 600 according to the sixth embodiment is a system that controls vibration of a vehicle body of a vehicle, the system including the information processing apparatus 20 according to the first embodiment described with reference to FIGS. 1 to 11.

The suspension control system 600 includes an electronically controlled suspension 610, an acceleration sensor 620, and the information processing apparatus 20.

The electronically controlled suspension 610 controls a suspension that suppresses vibration of the vehicle body. The electronically controlled suspension 610 controls the suspension according to a speed of the vehicle body, a road surface condition, a curvature of a curve, an acceleration, and the like.

The acceleration sensor 620 detects an acceleration of the vibration of the vehicle body.

The information processing apparatus 20 generates a control value for the electronically controlled suspension 610 so as to minimize the vibration of the vehicle body. More specifically, in estimation processing, the information processing apparatus 20 estimates the surrogate model obtained by modeling the black box function in which the output value is the acceleration of the vibration of the vehicle body. Furthermore, in sampling processing, the information processing apparatus 20 samples the output value based on the acceleration detected from the acceleration sensor 620. Then, in control process, the information processing apparatus 20 generates the control value for controlling a spring force and the like of the electronically controlled suspension 610.

A level of the vibration of the vehicle body caused by unevenness of a road surface, a level of swing at the time of making a curve, and a level of swing caused by a wind pressure change according to the control value such as the spring force set in the electronically controlled suspension 610.

For example, in a case of traveling on a gravel road, since the level of the vibration caused by the unevenness of the road surface is high, ride comfort of the vehicle is improved by decreasing the spring force set in the electronically controlled suspension 610. On the other hand, in a case of traveling on a curve of a paved road or changing a direction, the swing in a roll direction occurs or the swing in a pitch direction occurs at the time of acceleration or deceleration. Therefore, the ride comfort of the vehicle is improved by increasing the spring force set in the electronically controlled suspension 610.

Further, an optimum control value of the electronically controlled suspension 610 changes depending on a position of an occupant or a load, a gradient of the road surface, and the like. That is, the optimum control value of the electronically controlled suspension 610 changes depending on a surrounding environment at the time of traveling.

The information processing apparatus 20 can generate the control value of the electronically controlled suspension 610 so as to minimize the acceleration detected from the acceleration sensor 620 even if such a surrounding environment changes. As a result, the information processing apparatus 20 can control the control value of the electronically controlled suspension 610 so as to achieve optimum ride comfort. The information processing apparatus 20 may generate an evaluation value by combining the electronically controlled suspension 610 and at least one of a strength of an electronically controlled bumper, a level of a spring force of a device other than the electronically controlled suspension 610, a strength of the suspension, a height of the vehicle body, and the like, and generate the control value of the devices so as to optimize the evaluation value. Furthermore, in a case of controlling the level of the spring force of the device, the information processing apparatus 20 may generate the control value representing a length of the spring.

### Seventh Embodiment

Next, a vehicle control system 700 according to a seventh embodiment will be described.

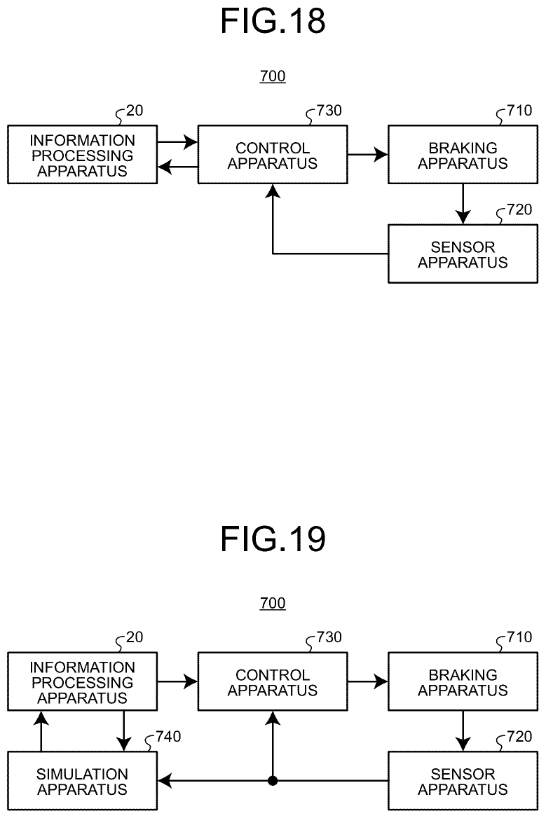

FIG. 18 is a diagram illustrating a first example of a configuration of the vehicle control system 700 according to the seventh embodiment. The vehicle control system 700 according to the seventh embodiment is a system that controls a braking force of a vehicle, the system including the information processing apparatus 20 according to the first embodiment described with reference to FIGS. 1 to 11.

The vehicle control system 700 includes a braking apparatus 710, a sensor apparatus 720, a control apparatus 730, and the information processing apparatus 20.

The braking apparatus 710 is an apparatus that stops traveling of the vehicle. The braking apparatus 710 controls the braking force for each of a plurality of tires included in the vehicle.

The sensor apparatus 720 detects a rotation speed of each of the plurality of tires. The sensor apparatus 720 may further detect an angular acceleration of each of the plurality of tires.

The control apparatus 730 controls the braking apparatus 710 such that the vehicle stops at a short distance or the vehicle travels in an appropriate posture. For example, in a case where a sudden brake operation is performed, the control apparatus 730 controls the braking force of each of the plurality of tires such that the plurality of tires are not locked. In addition, the control apparatus 730 controls the braking force of each of the plurality of tires such that the vehicle body is not laterally displaced while traveling on a curve.

The information processing apparatus 20 provides a control value to the control apparatus 730 such that the vehicle can stop at a short distance or the vehicle can travel in an appropriate posture. More specifically, in estimation processing, the information processing apparatus 20 estimates the surrogate model obtained by modeling the black box function in which the output values are the rotational speed of each of the plurality of tires and a matching degree between the posture of the vehicle body and a target posture. Furthermore, in sampling processing, the information processing apparatus 20 samples the rotation speed of each of the plurality of tires and the matching degree between the posture of the vehicle body and the target posture as the output values. Then, in control processing, the information processing apparatus 20 generates the control value for controlling the control apparatus 730 such that each of the plurality of tires is not locked and the posture of the vehicle body matches the target posture.

The vehicle is required to stop at a distance as short as possible at the time of performing the sudden braking operation. The vehicle adopting an anti-lock brake system can stop at a short distance even on a wet road surface or the like, for example, by controlling a strength of a brake of each of the plurality of tires. For example, the information processing apparatus 20 generates the braking force of each of the plurality of tires as the N discrete parameters.

In addition, in a case of traveling on a curve, the vehicle adopting a lateral displacement prevention system can prevent traveling on a trajectory displaced outward or inward as compared with a target trajectory based on a steering wheel operation amount or the like. For example, the vehicle adopting the lateral displacement prevention system controls the braking force in time series for each tire such that the vehicle body takes the target posture. For example, the information processing apparatus 20 generates, for example, a time-series pattern of the braking force for each of the plurality of tires as the N discrete parameters.

FIG. 19 is a diagram illustrating a second example of the configuration of the vehicle control system 700 according to the seventh embodiment.

The vehicle control system 700 may further include a simulation apparatus 740. The simulation apparatus 740 simulates a difference from the target posture in the vehicle body based on the time-series pattern of the braking force for each of the plurality of tires. Furthermore, the simulation apparatus 740 may simulate the rotation speed of each of the plurality of tires and the difference from the target posture in the vehicle body by using the actual rotation speed of each of the plurality of tires detected by the sensor apparatus 720.

In a case where the vehicle control system 700 includes the simulation apparatus 740, the information processing apparatus 20 samples a simulation result of the simulation apparatus 740 as the output value in the sampling processing. Then, in the control processing, the information processing apparatus 20 generates the control value for controlling the control apparatus 730 such that the posture of the vehicle body matches the target posture.

The vehicle control system 700 according to the seventh embodiment can control the braking force in time series for each tire and control the vehicle body to take the target posture even if such a simulation apparatus 740 is used.

### Hardware Configuration and the Like of Information Processing Apparatus 20

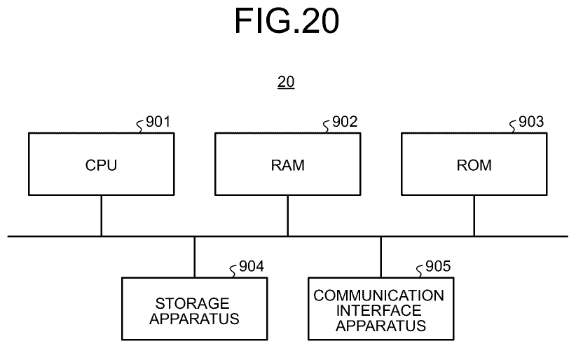

FIG. 20 is a diagram illustrating an example of a hardware configuration of the information processing apparatus 20. The information processing apparatus 20 is implemented by a computer having the hardware configuration as illustrated in FIG. 20, for example. The information processing apparatus 20 includes a central processing unit (CPU) 901, a random access memory (RAM) 902, a read only memory (ROM) 903, a storage apparatus 904, and a communication interface apparatus 905. These units are connected by a bus.

The CPU 901 is one or more processors that execute arithmetic operation processing, control processing, and the like according to a program. The CPU 901 uses a predetermined area of the RAM 902 as a work area, and executes various types of processing in cooperation with the program stored in the ROM 903, the storage apparatus 904, or the like.

The RAM 902 is a memory such as a synchronous dynamic random access memory (SDRAM). The RAM 902 functions as the work area of the CPU 901. The ROM 903 is a memory that stores the program and various types of information in a non-rewritable manner.

The storage apparatus 904 is an apparatus that writes and reads data in and from a semiconductor storage medium such as a flash memory, a magnetically or optically recordable storage medium, or the like. The storage apparatus 904 writes and reads data in and from the storage medium under the control of the CPU 901. The communication interface apparatus 905 communicates with an external device via a network under the control of the CPU 901.

The program executed by the computer causes the computer to function as the information processing apparatus 20. The program is loaded and executed on the RAM 902 by the CPU 901 (processor).

The program executed by the computer is provided by being recorded in a computer-readable recording medium such as a CD-ROM, a flexible disk, a CD-R, or a digital versatile disk (DVD) as a file in a format that can be installed or executed in the computer.

Further, the program may be stored in the computer such as a server connected to the network such as the Internet and may be provided by being downloaded via the network. Furthermore, the program may be provided or distributed via the network such as the Internet. The program executed by the information processing apparatus 20 may be provided by being incorporated in the ROM 903 or the like in advance.

The program for causing the computer to function as the information processing apparatus 20 has a module configuration including, for example, an estimation module, an optimization module, a control module, a sampling module, an addition module, a timing control module, and a deletion module. The program is executed by the CPU 901 to load each module into the RAM 902, and causes the CPU 901 to function as the estimation unit 24, the optimization unit 28, the control unit 30, the sampling unit 32, the addition unit 34, the timing control unit 36, and the deletion unit 38. In a case where the CPU 901 is a plurality of processors, these units may be implemented by the plurality of processors in a distributed manner. In addition, the program causes the RAM 902 and the storage apparatus 904 to function as the history storage unit 22 and the surrogate model storage unit 26. Some or all of the configurations may be implemented by hardware.

Furthermore, the information processing apparatus 20 includes a processing unit (a hardware processor) that functions as the estimation unit 24, the optimization unit 28, the control unit 30, the sampling unit 32, the addition unit 34, the timing control unit 36, and the deletion unit 38. The processing unit may be implemented by one or more reconfigurable semiconductor apparatuses such as a field-programmable gate array (FPGA). Furthermore, the processing unit may be implemented by an electronic circuit including one or more CPUs, microprocessors, graphics processing units (GPUs), application specific integrated circuits (ASICs), or circuits thereof. Furthermore, the processing unit may be implemented by an information processing apparatus such as a computer, a computer system configured by a plurality of computers or servers communicating with each other via the network, a PC cluster in which a plurality of computers execute information processing in cooperation, or the like.

Furthermore, in a case where the processing unit is implemented by the reconfigurable semiconductor apparatus such as the FPGA, circuit information (configuration data) written in the reconfigurable semiconductor apparatus to operate the reconfigurable semiconductor apparatus as the processing unit may be stored in the computer connected to the network such as the Internet and provided by being downloaded via the network. In addition, the circuit information (configuration data) written in the reconfigurable semiconductor apparatus to operate the reconfigurable semiconductor apparatus as the processing unit may be provided by being recorded in the computer-readable recording medium.

Furthermore, in a case where the processing unit is implemented by a semiconductor apparatus such as the ASIC, circuit information representing a configuration of a circuit described in a hardware description language used for designing and manufacturing the processing unit may be stored in the computer connected to the network such as the Internet and provided by being downloaded via the network. Furthermore, the circuit information representing the configuration of the circuit described in the hardware description language used for designing and manufacturing the processing unit may be provided by being recorded in the computer-readable recording medium.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

### Supplementary Note

Note that the above embodiments can be summarized in the following Technical Ideas.

### Technical Idea 1

An information processing apparatus including a hardware processor configured to repeatedly execute estimation processing, optimization processing, sampling processing, and addition processing, wherein
the hardware processor is configured to, in the estimation processing, estimate a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
the hardware processor is configured to, in the optimization processing, calculate, as the N discrete parameters, a solution to an optimization problem of minimizing or maximizing the surrogate model estimated in the estimation processing,
the hardware processor is configured to, in the sampling processing, sample the output value output from the black box function based on sample values obtained corresponding to the N discrete parameters calculated in the optimization processing,
the hardware processor is configured to, in the addition processing, add the history data including the N discrete parameters calculated in the optimization processing and the output value sampled in the sampling processing to the history data set, and
the hardware processor is configured to further execute deletion processing of deleting, from the history data set, at least a part of one or more pieces of the history data added in the addition processing before a predetermined number of times earlier or a predetermined time earlier.

### Technical Idea 2

The information processing apparatus according to Technical Idea 1, wherein the surrogate model is a quadratic function used for a factorization machine.

### Technical Idea 3

The information processing apparatus according to Technical Idea 1 or 2, wherein the hardware processor is configured to further execute control processing of generating a control value based on the N discrete parameters and providing the generated control value to a control target.

### Technical Idea 4

The information processing apparatus according to Technical Idea 3, wherein the hardware processor is configured to, in the sampling processing, acquire, as the sample value, a sensor value output from a sensor that observes the control target.

### Technical Idea 5

The information processing apparatus according to Technical Idea 3, wherein the hardware processor is configured to, in the sampling processing, acquire, as the sample value, a simulation result obtained by providing the N discrete parameters to a simulator that simulates an operation of the control target by information processing.

### Technical Idea 6

The information processing apparatus according to Technical Idea 5, wherein the simulator simulates the control target by using a sensor value output from a sensor that observes the control target.

### Technical Idea 7

The information processing apparatus according to any one of Technical Ideas 1 to 5, wherein the hardware processor is configured to further executes control processing of generating a plurality of control values arranged in time series based on the N discrete parameters, and providing the plurality of generated control values to a control target to control the control target according to a lapse of time based on the plurality of control values.

### Technical Idea 8

The information processing apparatus according to Technical Idea 7, wherein
each of the plurality of control values corresponds to any one of the N discrete parameters, and
the hardware processor is configured to further execute mapping processing of changing a correspondence relationship between the N discrete parameters included in the history data and the plurality of discrete variables in the surrogate model such that a time corresponding to a first discrete variable among the plurality of discrete variables in the surrogate model estimated in first estimation processing that is one of times of the estimation processing repeatedly executed coincides with a time corresponding to the first discrete variable in the surrogate model estimated in second estimation processing that is the estimation processing executed immediately after the first estimation processing.

### Technical Idea 9

The information processing apparatus according to any one of Technical Ideas 3 to 8, wherein
the hardware processor is configured to further execute evaluation processing of evaluating whether or not the control value generated based on the N discrete parameters satisfies a predetermined evaluation criterion, and
the hardware processor is configured to, in a case where the control value does not satisfy the predetermined evaluation criterion, in the control processing, provide, to the controlled object, the control value generated based on information different from the N discrete parameters instead of the control value generated based on the N discrete parameters.

### Technical Idea 10

The information processing apparatus according to any one of Technical Ideas 3 to 9, wherein the hardware processor is configured to provide the control value generated based on different information from the control value based on the N discrete parameters to the control target in a predetermined initial period after a start of control, and provides the control value based on the N discrete parameters to the control target after the predetermined initial period ends.

### Technical Idea 11

The information processing apparatus according to any one of Technical Ideas 3 to 10, wherein the hardware processor is configured to further execute duplication prevention processing of determining whether or not the N discrete parameters calculated in the optimization processing coincide with the N discrete parameters that are a basis of the control value provided to the control target a predetermined number of times earlier or a predetermined time earlier, and re-executing the optimization processing in a case where they coincide with each other.

### Technical Idea 12

The information processing apparatus according to any one of Technical Idea 1 to 11, wherein the hardware processor is configured to acquire the history data set generated in advance or the surrogate model generated in advance before the estimation processing executed first.

### Technical Idea 13

The information processing apparatus according to any one of Technical Ideas 1 to 12, wherein
the hardware processor is configured to, in the estimation processing, estimate a first surrogate model that is the surrogate model and a second surrogate model that is the surrogate model including a smaller number of coefficients than the first surrogate model, and
in the optimization processing, the information processing apparatus calculates the solution to the optimization problem by using one of the first surrogate model and the second surrogate model as the surrogate model according to a number of pieces of history data included in the history data set.

### Technical Idea 14

A vehicle control system including:
the information processing apparatus according to any one of Technical Ideas 3 to 9;
a motor that drives a vehicle;
a battery that supplies electric power to the motor and stores electric power regenerated from the motor;
an electric power generator that converts fuel into electric power and supplies the electric power to the battery;
an energy prediction apparatus that including a second hardware processor configured to predict energy consumed in a case where the vehicle travels according to a planned travel route; and
a simulation apparatus including a third hardware processor configured to simulate a time transition of a remaining level of the battery in a case where the vehicle travels according to the planned travel route, wherein
the hardware processor is configured to
   in the estimation processing, estimate the surrogate model obtained by modeling the black box function in which the output value is a value based on a state of the battery,
   in the sampling processing, provide the N discrete parameters to the simulation apparatus and samples, as the output value, a simulation result of the simulation apparatus, and
   in the control processing, generate the plurality of control values arranged in time series for controlling the electric power generator in time series.

### Technical Idea 15

A moving body control system including:
an engine that drives a moving body; and
a control apparatus that controls the engine, wherein
the control apparatus includes the information processing apparatus according to any one of Technical Ideas 3 to 9,
the hardware processor is configured to
   in the estimation processing, estimates the surrogate model obtained by modeling the black box function in which the output value is at least one of vibration, noise, and a gas emission amount of the moving body, and
   in the control processing, generates the control value for controlling the engine based on the N discrete parameters.

### Technical Idea 16

A moving body control system including:
a motor that drives a moving body;
a motor driver that drives the motor;
a first electric power storage apparatus that supplies electric power to the motor driver and stores electric power regenerated from the motor driver;
a second electric power storage apparatus that supplies electric power to the motor driver, stores electric power regenerated from the motor driver, and has a characteristic different from a characteristic of the first electric power storage apparatus;
an energy prediction apparatus including a second hardware processor configured to predict energy consumed in a case where the moving body moves according to a planned movement route;
a simulation apparatus including a third hardware processor configured to simulate a state of the first electric power storage apparatus in a case where the moving body moves according to the planned movement route; and
a control apparatus configured to control input and output of electric power between the motor driver and the first electric power storage apparatus and input and output of electric power between the motor driver and the second electric power storage apparatus, wherein
the control apparatus includes the information processing apparatus according to any one of Technical Ideas 3 to 9,
the hardware processor is configured to
   in the estimation processing, estimate the surrogate model obtained by modeling the black box function in which the output value is a value based on a time transition of a remaining level of the first electric power storage apparatus and a time transition of a remaining level of the second electric power storage apparatus,
   in the sampling processing, provide the N discrete parameters to the simulation apparatus and samples a simulation result of the simulation apparatus as the output value, and
   in the control processing, generate the plurality of control values arranged in time series for controlling the input and output of the electric power between the motor driver and the first electric power storage apparatus and the input and output of the electric power between the motor driver and the second electric power storage apparatus in time series.

### Technical Idea 17

An information processing method executed by an information processing apparatus, the information processing method including:
repeatedly executing, by the information processing apparatus, estimation processing, optimization processing, sampling processing, and addition processing, wherein
in the estimation processing, the information processing apparatus estimates a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
in the optimization processing, the information processing apparatus calculates, as the N discrete parameters, a solution to an optimization problem of minimizing or maximizing the surrogate model estimated in the estimation processing,
in the sampling processing, the information processing apparatus samples the output value output from the black box function based on sample values obtained corresponding to the N discrete parameters calculated in the optimization processing,
in the addition processing, the information processing apparatus adds the history data including the N discrete parameters calculated in the optimization processing and the output value sampled in the sampling processing to the history data set, and
the information processing apparatus further executes deletion processing of deleting, from the history data set, at least a part of one or more pieces of the history data added in the addition processing before a predetermined number of times earlier or a predetermined time earlier.

### Technical Idea 18

A program for causing a computer to function as an information processing apparatus, and causing the computer to repeatedly execute estimation processing, optimization processing, sampling processing, and addition processing,
in the estimation processing, the computer estimates a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
in the optimization processing, the computer calculates, as the N discrete parameters, a solution to an optimization problem of minimizing or maximizing the surrogate model estimated in the estimation processing,
in the sampling processing, the computer samples the output value output from the black box function based on sample values obtained corresponding to the N discrete parameters calculated in the optimization processing,
in the addition processing, the computer adds the history data including the N discrete parameters calculated in the optimization processing and the output value sampled in the sampling processing to the history data set, and
the computer further executes deletion processing of deleting, from the history data set, at least a part of one or more pieces of the history data added in the addition processing before a predetermined number of times earlier or a predetermined time earlier.

### Technical Idea 19

Circuit information described in a hardware description language and representing a configuration of a circuit, wherein
the circuit information causes the circuit to function as an information processing apparatus,
the information processing apparatus repeatedly executing estimation processing, optimization processing, sampling processing, and addition processing, wherein
in the estimation processing, the information processing apparatus estimates a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
in the optimization processing, the information processing apparatus calculates, as the N discrete parameters, a solution to an optimization problem of minimizing or maximizing the surrogate model estimated in the estimation processing,
in the sampling processing, the information processing apparatus samples the output value output from the black box function based on sample values obtained corresponding to the N discrete parameters calculated in the optimization processing,
in the addition processing, the information processing apparatus adds the history data including the N discrete parameters calculated in the optimization processing and the output value sampled in the sampling processing to the history data set, and
the information processing apparatus further executes deletion processing of deleting, from the history data set, at least a part of one or more pieces of the history data added in the addition processing before a predetermined number of times earlier or a predetermined time earlier.

### Technical Idea 20

Circuit information written in a reconfigurable semiconductor apparatus for operating the reconfigurable semiconductor apparatus, wherein
the circuit information causes the reconfigurable semiconductor apparatus to function as an information processing apparatus,
the information processing apparatus repeatedly executing estimation processing, optimization processing, sampling processing, and addition processing, wherein
in the estimation processing, the information processing apparatus estimates a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
in the optimization processing, the information processing apparatus calculates, as the N discrete parameters, a solution to an optimization problem of minimizing or maximizing the surrogate model estimated in the estimation processing,
in the sampling processing, the information processing apparatus samples the output value output from the black box function based on sample values obtained corresponding to the N discrete parameters calculated in the optimization processing,
in the addition processing, the information processing apparatus adds the history data including the N discrete parameters calculated in the optimization processing and the output value sampled in the sampling processing to the history data set, and
the information processing apparatus further executes deletion processing of deleting, from the history data set, at least a part of one or more pieces of the history data added in the addition processing before a predetermined number of times earlier or a predetermined time earlier.

What is claimed is:

1. An information processing apparatus comprising
a hardware processor configured to repeatedly execute estimation processing, optimization processing, sampling processing, and addition processing, wherein
the hardware processor is configured to, in the estimation processing, estimate a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
the hardware processor is configured to, in the optimization processing, calculate, as the N discrete parameters, a solution to an optimization problem of minimizing or maximizing the surrogate model estimated in the estimation processing,
the hardware processor is configured to, in the sampling processing, sample the output value output from the black box function based on sample values obtained corresponding to the N discrete parameters calculated in the optimization processing,
the hardware processor is configured to, in the addition processing, add the history data including the N discrete parameters calculated in the optimization processing and the output value sampled in the sampling processing to the history data set, and
the hardware processor is configured to further execute deletion processing of deleting, from the history data set, at least a part of one or more pieces of the history data added in the addition processing before a predetermined number of times earlier or a predetermined time earlier.

2. The apparatus according to claim 1, wherein the surrogate model is a quadratic function used for a factorization machine.

3. The apparatus according to claim 1, wherein the hardware processor is configured to further execute control processing of generating a control value based on the N discrete parameters and providing the generated control value to a control target.

4. The apparatus according to claim 3, wherein the hardware processor is configured to, in the sampling processing, acquire, as the sample value, a sensor value output from a sensor that observes the control target.

5. The apparatus according to claim 3, wherein the hardware processor is configured to, in the sampling processing, acquire, as the sample value, a simulation result obtained by providing the N discrete parameters to a simulator that simulates an operation of the control target by information processing.

6. The apparatus according to claim 5, wherein the simulator simulates the control target by using a sensor value output from a sensor that observes the control target.

7. The apparatus according to claim 1, wherein the hardware processor is configured to further execute control processing of generating a plurality of control values arranged in time series based on the N discrete parameters, and providing the plurality of generated control values to a control target to control the control target according to a lapse of time based on the plurality of control values.

8. The apparatus according to claim 7, wherein
each of the plurality of control values corresponds to any one of the N discrete parameters, and
the hardware processor is configured to further execute mapping processing of changing a correspondence relationship between the N discrete parameters included in the history data and the plurality of discrete variables in the surrogate model such that a time corresponding to a first discrete variable among the plurality of discrete variables in the surrogate model estimated in first estimation processing that is one of times of the estimation processing repeatedly executed coincides with a time corresponding to the first discrete variable in the surrogate model estimated in second estimation processing that is the estimation processing executed immediately after the first estimation processing.

9. The apparatus according to claim 3, wherein
the hardware processor is configured to further execute evaluation processing of evaluating whether or not the control value generated based on the N discrete parameters satisfies a predetermined evaluation criterion, and
the hardware processor is configured to, in a case where the control value does not satisfy the predetermined evaluation criterion, in the control processing, provide, to the controlled object, the control value generated based on information different from the N discrete parameters instead of the control value generated based on the N discrete parameters.

10. The apparatus according to claim 3, wherein the hardware processor is configured to provide the control value generated based on different information from the control value based on the N discrete parameters to the control target in a predetermined initial period after a start of control, and provide the control value based on the N discrete parameters to the control target after the predetermined initial period ends.

11. The apparatus according to claim 3, wherein the hardware processor is configured to further execute duplication prevention processing of determining whether or not the N discrete parameters calculated in the optimization processing coincide with the N discrete parameters that are a basis of the control value provided to the control target a predetermined number of times earlier or a predetermined time earlier, and re-executing the optimization processing in a case where they coincide with each other.

12. The apparatus according to claim 1, wherein the hardware processor is configured to acquire the history data set generated in advance or the surrogate model generated in advance before the estimation processing executed first.

13. The apparatus according to claim 1, wherein
the hardware processor is configured to, in the estimation processing, estimate a first surrogate model that is the surrogate model and a second surrogate model that is the surrogate model including a smaller number of coefficients than the first surrogate model, and
in the optimization processing, the information processing apparatus calculates the solution to the optimization problem by using one of the first surrogate model and the second surrogate model as the surrogate model according to a number of pieces of history data included in the history data set.

14. A vehicle control system comprising:
the information processing apparatus according to claim 7;
a motor that drives a vehicle;
a battery that supplies electric power to the motor and stores electric power regenerated from the motor;
an electric power generator that converts fuel into electric power and supplies the electric power to the battery;
an energy prediction apparatus including a second hardware processor configured to predict energy consumed in a case where the vehicle travels according to a planned travel route; and
a simulation apparatus including a third hardware processor configured to simulate a time transition of a remaining level of the battery in a case where the vehicle travels according to the planned travel route, wherein
the hardware processor is configured to
in the estimation processing, estimate the surrogate model obtained by modeling the black box function in which the output value is a value based on a state of the battery,
in the sampling processing, provide the N discrete parameters to the simulation apparatus and samples, as the output value, a simulation result of the simulation apparatus, and
in the control processing, generate the plurality of control values arranged in time series for controlling the electric power generator in time series.

15. A moving body control system comprising:
an engine that drives a moving body; and
a control apparatus that controls the engine, wherein
the control apparatus includes the information processing apparatus according to claim 3,
the hardware processor is configured to
in the estimation processing, estimate the surrogate model obtained by modeling the black box function in which the output value is at least one of vibration, noise, and a gas emission amount of the moving body, and
in the control processing, generate the control value for controlling the engine based on the N discrete parameters.

16. A moving body control system comprising:
a motor that drives a moving body;
a motor driver that drives the motor;
a first electric power storage apparatus that supplies electric power to the motor driver and stores electric power regenerated from the motor driver;
a second electric power storage apparatus that supplies electric power to the motor driver, stores electric power regenerated from the motor driver, and has a characteristic different from a characteristic of the first electric power storage apparatus;
an energy prediction apparatus including a second hardware processor configured to predict energy consumed in a case where the moving body moves according to a planned movement route;
a simulation apparatus including a third hardware processor configured to simulate a state of the first electric power storage apparatus in a case where the moving body moves according to the planned movement route; and
a control apparatus configured to control input and output of electric power between the motor driver and the first electric power storage apparatus and input and output of electric power between the motor driver and the second electric power storage apparatus, wherein
the control apparatus includes the information processing apparatus according to claim 7,
the hardware processor is configured to
in the estimation processing, estimate the surrogate model obtained by modeling the black box function in which the output value is a value based on a time transition of a remaining level of the first electric power storage apparatus and a time transition of a remaining level of the second electric power storage apparatus,
in the sampling processing, provide the N discrete parameters to the simulation apparatus and samples a simulation result of the simulation apparatus as the output value, and
in the control processing, generate the plurality of control values arranged in time series for controlling the input and output of the electric power between the motor driver and the first electric power storage apparatus and the input and output of the electric power between the motor driver and the second electric power storage apparatus in time series.

17. An information processing method executed by an information processing apparatus, the information processing method comprising:
repeatedly executing, by the information processing apparatus, estimation processing, optimization processing, sampling processing, and addition processing, wherein
in the estimation processing, the information processing apparatus estimates a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
in the optimization processing, the information processing apparatus calculates, as the N discrete parameters, a solution to an optimization problem of minimizing or maximizing the surrogate model estimated in the estimation processing,
in the sampling processing, the information processing apparatus samples the output value output from the black box function based on sample values obtained corresponding to the N discrete parameters calculated in the optimization processing,
in the addition processing, the information processing apparatus adds the history data including the N discrete parameters calculated in the optimization processing and the output value sampled in the sampling processing to the history data set, and
the information processing apparatus further executes deletion processing of deleting, from the history data set, at least a part of one or more pieces of the history data added in the addition processing before a predetermined number of times earlier or a predetermined time earlier.

18. A computer program product comprising a non-transitory computer-readable medium including programmed instructions, the instructions causing a computer to function as an information processing apparatus, and causing the computer to repeatedly execute estimation processing, optimization processing, sampling processing, and addition processing,
in the estimation processing, the computer estimates a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
in the optimization processing, the computer calculates, as the N discrete parameters, a solution to an optimization problem of minimizing or maximizing the surrogate model estimated in the estimation processing,
in the sampling processing, the computer samples the output value output from the black box function based on sample values obtained corresponding to the N discrete parameters calculated in the optimization processing,
in the addition processing, the computer adds the history data including the N discrete parameters calculated in the optimization processing and the output value sampled in the sampling processing to the history data set, and
the computer further executes deletion processing of deleting, from the history data set, at least a part of one or more pieces of the history data added in the addition processing before a predetermined number of times earlier or a predetermined time earlier.

19. A computer program product having a non-transitory computer readable medium including circuit information described in a hardware description language and representing a configuration of a circuit, wherein
the circuit information causes the circuit to function as an information processing apparatus,
the information processing apparatus repeatedly executing estimation processing, optimization processing, sampling processing, and addition processing, wherein
in the estimation processing, the information processing apparatus estimates a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
in the optimization processing, the information processing apparatus calculates, as the N discrete parameters, a solution to an optimization problem of minimizing or maximizing the surrogate model estimated in the estimation processing,
in the sampling processing, the information processing apparatus samples the output value output from the black box function based on sample values obtained corresponding to the N discrete parameters calculated in the optimization processing,
in the addition processing, the information processing apparatus adds the history data including the N discrete parameters calculated in the optimization processing and the output value sampled in the sampling processing to the history data set, and
the information processing apparatus further executes deletion processing of deleting, from the history data set, at least a part of one or more pieces of the history data added in the addition processing before a predetermined number of times earlier or a predetermined time earlier.

20. A server comprising:
the computer program product according to claim 19.

21. A computer program product having a non-transitory computer readable medium including circuit information written in a reconfigurable semiconductor apparatus for operating the reconfigurable semiconductor apparatus, wherein
the circuit information causes the reconfigurable semiconductor apparatus to function as an information processing apparatus,
the information processing apparatus repeatedly executing estimation processing, optimization processing, sampling processing, and addition processing, wherein
in the estimation processing, the information processing apparatus estimates a surrogate model that is obtained by modeling a black box function based on a history data set, and is a function including a plurality of discrete variables,
the history data set includes history data including N discrete parameters input to the black box function and an output value output from the black box function in response to input of the N discrete parameters, N being an integer of 2 or more,
in the optimization processing, the information processing apparatus calculates, as the N discrete parameters, a solution to an optimization problem of minimizing or maximizing the surrogate model estimated in the estimation processing,
in the sampling processing, the information processing apparatus samples the output value output from the black box function based on sample values obtained corresponding to the N discrete parameters calculated in the optimization processing,
in the addition processing, the information processing apparatus adds the history data including the N discrete parameters calculated in the optimization processing and the output value sampled in the sampling processing to the history data set, and
the information processing apparatus further executes deletion processing of deleting, from the history data set, at least a part of one or more pieces of the history data added in the addition processing before a predetermined number of times earlier or a predetermined time earlier.

22. A server comprising:
the computer program product according to claim 21.
